(19) United States
(12) Patent Application Publication
(10) Pub. No.: US 2025/0070909 A1
(43) Pub. Date: Feb. 27, 2025

(54) APPARATUS, SYSTEM, AND METHOD OF FORWARD ERROR CORRECTION (FEC) CODING

(71) Applicants: Juan Fang, Portland, OR (US); Qinghua Li, San Ramon, CA (US); Danny Alexander, Monoson (IL); Shlomi Vituri, Tel Aviv (IL); Robert Stacey, Portland, OR (US)

(72) Inventors: Juan Fang, Portland, OR (US); Qinghua Li, San Ramon, CA (US); Danny Alexander, Monoson (IL); Shlomi Vituri, Tel Aviv (IL); Robert Stacey, Portland, OR (US)

(21) Appl. No.: 18/940,880

(22) Filed: Nov. 8, 2024

Related U.S. Application Data
(60) Provisional application No. 63/597,401, filed on Nov. 9, 2023.

(51) Int. Cl. H04L 1/00

(52) U.S. Cl. CPC H04L 1/0008; H04L 1/0041

(57) ABSTRACT

For example, a STA may determine a pre-FEC padding factor value for a PPDU, the pre-FEC padding factor value in a range between 1 and 2^{Na}, wherein Na is an integer greater than 2; set Na bits in a Signal (SIG) field of the PPDU to indicate the pre-FEC padding factor value; and encode a data field of the PPDU according to a FEC coding based on the pre-FEC padding factor value. For example, a STA may encode a data field of a PPDU according to a FEC coding based on a pre-FEC padding factor value and based on a condition that no post-FEC padding is to be applied for the PPDU; and set an LDPC extra symbol subfield in a SIG field of the PPDU to indicate whether or not an LDPC extra symbol is present based on encoding of the data field of the PPDU.

### CROSS REFERENCE

This application claims the benefit of and priority from U.S. Provisional Patent Application No. 63/597,401 entitled “Enhanced Low-Density Parity-Check (LDPC) for 802.11BN”, filed Nov. 9, 2023, the entire disclosure of which is incorporated herein by reference.

### BACKGROUND

Devices in a wireless communication system may be configured to communicate according to communication protocols, which may utilize a Forward Error Correction (FEC) coding for a data field of a Physical Layer (PHY) Protocol Data Unit (PPDU).

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a method of pre Forward Error Correction (FEC) (pre-FEC) padding, in accordance with some demonstrative aspects.

FIG. 3 is a schematic flow-chart illustration of a method of FEC coding, in accordance with some demonstrative aspects.

FIG. 4 is a schematic flow-chart illustration of a method of FEC coding, in accordance with some demonstrative aspects.

FIG. 5 is a schematic flow-chart illustration of a method of FEC coding, in accordance with some demonstrative aspects.

FIG. 6 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. Any aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology-Telecommunications and Information Exchange between Systems Local and Metropolitan Area Networks-Specific Requirements; Part 11: Wireless LAN Medium Access Control (MAC) and Physical Layer (PHY) Specifications, December 2020); IEEE 802.11ax (IEEE 802.11ax-2021, IEEE Standard for Information Technology Telecommunications and Information Exchange between Systems Local and Metropolitan Area Networks-Specific Requirements; Part 11: Wireless LAN Medium Access Control (MAC) and Physical Layer (PHY) Specifications; Amendment 1: Enhancements for High-Efficiency WLAN, February 2021); IEEE 802.11be (IEEE P802.11be/D5.0 Draft Standard for Information technology Telecommunications and information exchange between systems Local and metropolitan area networks Specific requirements; Part 11: Wireless LAN Medium Access Control (MAC) and Physical Layer (PHY) Specifications; Amendment 8: Enhancements for extremely high throughput (EHT), November 2023); and/or IEEE802.11bn (IEEE 802.11bn, IEEE Standard for Information Technology Telecommunications and Information Exchange between Systems Local and Metropolitan Area Networks Specific Requirements; Part 11: Wireless LAN Medium Access Control (MAC) and Physical Layer (PHY) Specifications Amendment: Enhancements for Ultra High Reliability (UHR))) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™ Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a Wi-Fi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 GHz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (SIG) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

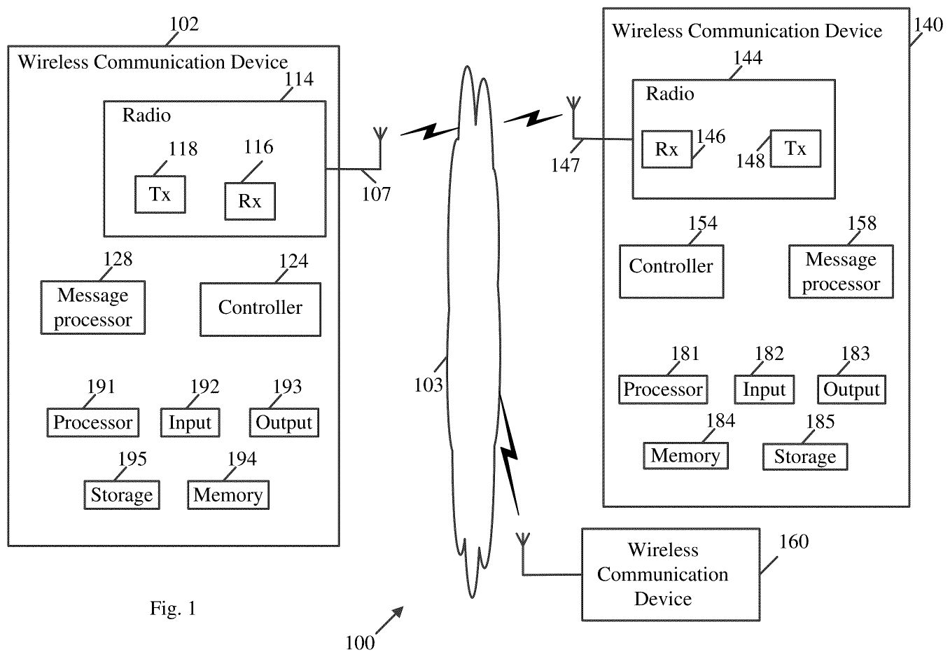

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a Wi-Fi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 GHz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include one or more radios 114, and/or device 140 may include one or more radios 144.

In some demonstrative aspects, radios 114 and/or radios 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an SIG band, and/or any other band.

In some demonstrative aspects, radios 114 and/or 144 may include, or may be associated with one or more antennas.

In some demonstrative aspects, device 102 may include one or more antennas 107, and/or device 140 may include one or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 160 may be configured to perform one or more operations, and/or functionalities of a Wi-Fi 8 STA.

In other aspects, for example, devices 102, 140 and/or 160 may be configured to perform one or more operations, and/or functionalities of an Ultra High Reliability (UHR) STA.

In other aspects, for example, devices 102, 140, and/or 160 may be configured to perform one or more operations, and/or functionalities of any other additional or alternative type of STA.

In other aspects, device 102, device 140, and/or device 160 may include, operate as, perform the role of, and/or perform one or more functionalities of, any other wireless device and/or station, e.g., a WLAN STA, a Wi-Fi STA, and the like.

In some demonstrative aspects, device 102, device 140, and/or device 160 may be configured operate as, perform the role of, and/or perform one or more functionalities of, an Access Point (AP), e.g., a High Throughput (HT) AP STA, a High Efficiency (HE) AP STA, an EHT AP STA and/or a UHR AP STA.

In some demonstrative aspects, device 102, device 140, and/or device 160 may be configured to operate as, perform the role of, and/or perform one or more functionalities of, a non-AP STA, e.g., an HT non-AP STA, an HE non-AP STA, an EHT non-AP STA and/or a UHR non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102, 140, and/or 160 may be configured to communicate in an HT network, an HE network, an EHT network, a UHR network, and/or any other network.

In some demonstrative aspects, devices 102, 140 and/or 160 may be configured to operate in accordance with one or more Specifications, for example, including one or more IEEE 802.11 Specifications, e.g., an IEEE 802.11-2020 Specification, an IEEE 802.11ax Specification, an IEEE 802.11be Specification, an IEEE 802.11bn Specification, and/or any other specification and/or protocol.

In some demonstrative aspects, device 102, device 140, and/or device 160 may include, operate as, perform a role of, and/or perform the functionality of, a Multi-Link Device (MLD). For example, device 102 may include, operate as, perform a role of, and/or perform the functionality of, at least one MLD, device 140 may include, operate as, perform a role of, and/or perform the functionality of, at least one MLD, and/or device 160 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140, and/or device 160 may be configured to operate as, perform the role of, and/or perform one or more functionalities of, an AP MLD.

In some demonstrative aspects, device 102, device 140, and/or device 160 may be configured to operate as, perform the role of, and/or perform one or more functionalities of, a non-AP MLD.

In other aspects, device 102, device 140, and/or device 160 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In some demonstrative aspects, device 102, device 140, and/or device 160 may include, operate as, perform a role of, and/or perform the functionality of, one or more AP STAs and/or one or more non-AP STAs. In one example, device 102 may include, operate as, perform a role of, and/or perform the functionality of, at least one AP STA, and/or device 140 may include, operate as, perform a role of, and/or perform the functionality of, at least one non-AP STA.

In some demonstrative aspects, device 102 may include, operate as, perform a role of, and/or perform the functionality of, a first STA, e.g., an AP STA or a non-AP STA.

In some demonstrative aspects, device 140 may include, operate as, perform a role of, and/or perform the functionality of, a second STA, e.g., an AP STA or a non-AP STA.

In some demonstrative aspects, device 160 may include, operate as, perform a role of, and/or perform the functionality of, a third STA, e.g., an AP STA or a non-AP STA.

In other aspects, device 102, device 140, and/or device 160 may include, operate as, perform a role of, and/or perform the functionality of any other additional or alternative type of STA.

In some demonstrative aspects, device 102, device 140, and/or device 160 may be configured to communicate one or more PPDUs, for example, in accordance with an IEEE 802.11 Specification.

In some demonstrative aspects, device 102, device 140, and/or device 160 may be configured to generate, transmit, receive, and/or process one or more transmissions of PPDUs, e.g., as described below.

In some demonstrative aspects, device 102, device 140, and/or device 160 may be configured to encode data according to a Forward Error Correction (FEC) coding, e.g., as described below.

In some demonstrative aspects, device 102, device 140, and/or device 160 may be configured to perform a FEC padding of a data field according to a FEC padding mechanism, e.g., as described below.

In some demonstrative aspects, the FEC padding may be configured to include a pre-FEC padding, e.g., as described below.

In some demonstrative aspects, the FEC padding may be configured to include a post-FEC padding, e.g., as described below.

For example, the FEC padding may be configured to pad a data field of a PPDU according to a two-step padding process, e.g., as described below.

For example, the two-step padding process may be applied to a UHR PPDU, and/or any other type of PPDU.

In some demonstrative aspects, the two-step padding process may include one or more operations in compliance with a padding process defined by an IEEE 802.11ax Specification.

For example, the two-step padding procedure may include a pre-FEC padding, and a post-FEC padding. For example, the pre-FEC padding may include a pre-FEC MAC padding and a pre-FEC PHY padding, which may be applied for example, before conducting FEC coding to provide FEC encoded bits.

For example, the post-FEC padding may include a post-FEC PHY padding process, which may be applied on the FEC encoded bits.

In some demonstrative aspects, the FEC padding may be configured to utilize a reduced, e.g., minimized, post-FEC padding, e.g., as described below.

In some demonstrative aspects, the FEC padding may be configured to exclude, omit and/or avoid a post-FEC padding, e.g., as described below.

In some demonstrative aspects, device 102, device 140, and/or device 160 may be configured to perform a pre-FEC padding of a data field according to a pre-FEC padding mechanism, e.g., as described below.

In some demonstrative aspects, the pre-FEC padding mechanism may be configured based on one or more operations, functions, and/or procedures of a pre-FEC padding process, e.g., in accordance with an IEEE 802.11 Standard.

For example, the pre-FEC padding mechanism may be configured based on one or more operations and/or procedures of a pre-FEC padding process, e.g., in accordance with an IEEE 802.11ac Specification, an IEEE 802.11ax Specification, and/or an IEEE 802.11be Specification.

For example, a pre-FEC padding, e.g., in accordance with the IEEE 802.11 Specifications, may lock a Low-Density Parity-Check (LDPC) encoding to a predefined payload length.

For example, in some use cases, scenarios, and/or implementations, locking the LDPC encoding to a predefined payload, e.g., in accordance with the IEEE 802.11 Specifications, may lead to performance degradation.

For example, locking the LDPC encoding to the predefined payload length may lead to a large padding ratio, e.g., in case of relatively small data payload sizes.

For example, applying a pre-FEC padding to a PSDU of a relatively small size may result in a relatively high padding ratio.

For example, when encoding a PSDU without pre-FEC padding, e.g., in accordance with an IEEE 802.11n Specification, an OFDM symbol boundary may be filled with repeated information & parity bits. For example, the repetition bits may be used, e.g., rather than puncturing bits. For example, a ratio between the number of padding bits and a PSDU size, may be 0%, e.g., regardless of the PSDU size.

For example, when encoding a PSDU with pre-FEC padding, e.g., in accordance with an IEEE 802.11ac Specification, padding bits may be utilized, for example, to fill the OFDM symbol boundary. For example, the pre-FEC padding may be configured such that a MAC boundary of a PPDU may overlap with a PHY boundary of the PPDU, for example, when an LDPC extra symbol segment is not present. For example, this padding may result in a relatively high padding ratio, e.g., in situations where a relatively large number of padding bits is used. For example, the padding ratio may increase, e.g., as the size of the PSDU decreases. The use of a relatively large number of padding bits may lead to suboptimal performance, for example, for small payload sizes, e.g., when communicated according to one or more bandwidth and/or Modulation and Coding Scheme (MCS) settings.

For example, a setting of a padding factor, e.g., a pre-FEC padding factor, denoted a, e.g., in accordance with an IEEE 802.11ax Specification, may be utilized to mitigate, e.g., at least partially mitigate, the performance degradation due to the pre-FEC padding. For example, a setting the pre-FEC padding factor a, e.g., in accordance with an IEEE 802.11ax Specification, may be utilized to reduce the pre-FEC padding to be up to one-quarter of an OFDM symbol, e.g., instead of one OFDM symbol. However, in some cases, a padding ratio may still be relatively high, e.g., even if the pre-FEC padding factor is implemented. For example, even when setting the pre-FEC padding factor a, e.g., in accordance with an IEEE 802.11ax Specification, a remaining part of the last OFDM symbol may be filled with post-FEC padding, which are dummy bits. The use of the post-FEC padding may result in a reduced Packet Extension (PE) duration, and may complicate an LDPC coding algorithm and/or a PE value setting. On the other hand, packet extension may not be required for all packets.

For example, an efficiency of the pre-FEC padding, e.g., in accordance with an IEEE 802.11ac Specification and/or an IEEE 802.11ax Specification, may be lower than an efficiency without pr-FEC padding, e.g., in accordance with an IEEE 802.11n Specification, for example, for relatively short packets.

For example, in many scenarios, e.g., a home scenario or the like, a relatively large portion of traffic may include short packets. Accordingly, implementing the pre-FEC padding, e.g., in accordance with an IEEE 802.11ac Specification and/or an IEEE 802.11ax Specification, may result in degraded performance in these scenarios.

In some demonstrative aspects, device 102, device 140, and/or device 160 may be configured to implement a FEC padding mechanism, which may be configured to provide a technical solution to support a reduced padding ratio, for example, a minimized padding ratio, e.g., as described below.

For example, a relatively large padding ratio may lead to suboptimal performance for some PSDUs, e.g., PSDUs with a relatively small payload sizes and/or a certain data rate.

In some demonstrative aspects, the FEC padding mechanism may be configured to provide a technical solution to mitigate this performance degradation, for example, by reducing, e.g., minimizing, a padding ratio, e.g., as described below.

In some demonstrative aspects, the FEC padding mechanism may be configured to provide a technical solution to reduce, e.g., minimize, the padding ratio, for example, by increasing the granularity of the pre-FEC padding factor a, e.g., as described below.

In some demonstrative aspects, the FEC padding mechanism may be configured to provide a technical solution to reduce, e.g., minimize, the padding ratio, for example, by reducing, e.g., minimizing, the number of post-FEC padding bits, e.g., as described below.

In some demonstrative aspects, the FEC padding mechanism may be configured to provide a technical solution to reduce, e.g., minimize, the padding ratio, for example, by using a post-FEC padding factor, e.g., as described below.

In some demonstrative aspects, the FEC padding mechanism may be configured to provide a technical solution to reduce, e.g., minimize, the padding ratio, for example, by using a post-FEC padding factor with an increased granularity, e.g., as described below.

In some demonstrative aspects, the FEC padding mechanism may be configured to provide a technical solution to reduce, e.g., minimize, the padding ratio, for example, by excluding, omitting, and/or prohibiting the post-FEC padding, e.g., as described below.

In some demonstrative aspects, the FEC padding mechanism may be configured to provide a technical solution to reduce, e.g., minimize or even exclude, post-FEC padding bits, for example, by replacing some, or even all, of the post-FEC padding bits with useful data signals, e.g., as described below.

In some demonstrative aspects, the FEC padding mechanism may be configured to provide a technical solution to reduce, e.g., minimize or even exclude, post-FEC padding bits, for example, by replacing some, or even all, of the post-FEC padding bits with information based on the data field, e.g., as described below.

In some demonstrative aspects, the FEC padding mechanism may be configured to provide a technical solution to reduce, e.g., minimize or even exclude, post-FEC padding bits, for example, by replacing some, or even all, of the post-FEC padding bits with repeated information and/or parity bits, e.g., as described below.

In some demonstrative aspects, device 102, device 140, and/or device 160 may be configured to implement a FEC padding mechanism, which may be configured according to a first FEC padding technique utilizing an increased pre-FEC padding factor, e.g., as described below.

In some demonstrative aspects, device 102, device 140, and/or device 160 may be configured to implement a FEC padding mechanism, which may be configured according to a second FEC padding technique utilizing a post-FEC padding factor, e.g., as described below.

In some demonstrative aspects, device 102, device 140, and/or device 160 may be configured to implement a FEC padding mechanism, which may be configured according to the first FEC padding technique and the second FEC padding technique, e.g., as described below.

In some demonstrative aspects, device 102, device 140, and/or device 160 may be configured to implement a FEC padding mechanism, which may be configured according to the first FEC padding technique, e.g., while excluding the second FEC padding technique, e.g., as described below.

In some demonstrative aspects, device 102, device 140, and/or device 160 may be configured to implement a FEC padding mechanism, which may be configured according to the second FEC padding technique, e.g., while excluding the first FEC padding technique, e.g., as described below.

In some demonstrative aspects, device 102, device 140, and/or device 160 may be configured to implement a FEC padding mechanism, which may be configured according to a third FEC padding technique, which may be configured based on a condition that no post-FEC padding is to be applied for an encoded PPDU, e.g., as described below.

In some demonstrative aspects, device 102, device 140, and/or device 160 may be configured to implement a FEC padding mechanism, which may be configured according to the third FEC padding technique and the second FEC padding technique, for example, while setting the post-FEC padding factor such that no post-FEC padding is to be applied, e.g., as described below.

In some demonstrative aspects, device 102, device 140, and/or device 160 may be configured to implement a FEC padding mechanism, which may be configured according to the third FEC padding technique, e.g., while excluding the second FEC padding technique, e.g., as described below.

In some demonstrative aspects, device 102, device 140, and/or device 160 may be configured to implement a FEC padding mechanism, which may be configured according to the first FEC padding technique and the third FEC padding technique, e.g., as described below.

In some demonstrative aspects, device 102, device 140, and/or device 160 may be configured to implement a FEC padding mechanism, which may be configured according to the first FEC padding technique, the second FEC padding technique, and the third FEC padding technique, e.g., as described below.

In some demonstrative aspects, device 102, device 140, and/or device 160 may be configured to implement a FEC padding mechanism, which may be configured according to the first FEC padding technique, e.g., while excluding the third FEC padding technique, e.g., as described below.

In some demonstrative aspects, device 102, device 140, and/or device 160 may be configured to implement a FEC padding mechanism, which may be configured according to the third FEC padding technique, e.g., while excluding the first FEC padding technique, e.g., as described below.

In some demonstrative aspects, controller 124 may be configured to control, trigger, cause, and/or instruct a STA implemented by device 102 to determine a pre Forward Error Correction (FEC) (pre-FEC) padding factor value for a Physical Layer (PHY) Protocol Data Unit (PPDU), for example, according to the first FEC padding technique, e.g., as described below.

In some demonstrative aspects, controller 124 may be configured to control, trigger, cause, and/or instruct the STA implemented by device 102 to determine the pre-FEC padding factor value in a range between 1 and 2Na, wherein Na is an integer greater than 2, e.g., as described below.

In some demonstrative aspects, controller 124 may be configured to control, trigger, cause, and/or instruct the STA implemented by device 102 to set Na bits in a Signal (SIG) field of the PPDU to indicate the pre-FEC padding factor value, e.g., as described below.

In some demonstrative aspects, controller 124 may be configured to control, trigger, cause, and/or instruct the STA implemented by device 102 to encode a data field of the PPDU according to a FEC coding based on the pre-FEC padding factor value, e.g., as described below.

In some demonstrative aspects, the value of Na may correspond to, and/or may represent, a number of bits, which may be used to indicate the pre-FEC padding factor value, e.g., as described below.

In some demonstrative aspects, the value of Na may correspond to, and/or may represent, a granularity level of the pre-FEC padding factor value, e.g., as described below.

In some demonstrative aspects, the value of Na may correspond to, and/or may represent, a granularity level of possibilities to set the MAC boundary, e.g., as described below. For example, a higher value of Na may correspond to, and/or may represent, a higher granularity level of possibilities to set the MAC boundary. In one example, value of Na=2 may correspond to, and/or may represent, a granularity of 1/(22)=1/4 of an OFDM symbol for setting the MAC boundary. In another example, value of Na=3 may correspond to, and/or may represent, a granularity of 1/(23)=1/8 of an OFDM symbol for setting the MAC boundary.

In some demonstrative aspects, the FEC coding may include a Low-Density Parity Check (LDPC) coding, e.g., as described below.

In other aspects, the FEC coding may include any other additional or alternative suitable type of FEC coding.

In some demonstrative aspects, the PPDU may include a Multi-User (MU) PPDU for a plurality of users, e.g., as described below.

In some demonstrative aspects, controller 124 may be configured to control, trigger, cause, and/or instruct the STA implemented by device 102 to determine the pre-FEC padding factor value to include a common pre-FEC padding factor value to be applied for all users in the plurality of users, e.g., as described below.

In other aspects, the PPDU may include a Single-User (SU) PPDU for a single user, e.g., as described below.

In some demonstrative aspects, controller 124 may be configured to control, trigger, cause, and/or instruct the STA implemented by device 102 to determine the pre-FEC padding factor value based on the value Na=3, e.g., as described below.

In other aspects controller 124 may be configured to control, trigger, cause, and/or instruct the STA implemented by device 102 to determine the pre-FEC padding factor value based on the value Na=4, or based on any other suitable value of Na.

In some demonstrative aspects, controller 124 may be configured to control, trigger, cause, and/or instruct the STA implemented by device 102 to set the Na bits including bits B10-B11 of the SIG field, and a bit of bits B13-B17 of the SIG field, e.g., as described below.

In other aspects, controller 124 may be configured to control, trigger, cause, and/or instruct the STA implemented by device 102 to set the Na bits including any other additional or alternative bits of the SIG field.

In some demonstrative aspects, controller 124 may be configured to control, trigger, cause, and/or instruct the STA implemented by device 102 to determine the pre-FEC padding factor value, for example, based on a number of data bits left in a last Orthogonal Frequency Division Multiplexing (OFDM) symbol of the PPDU, e.g., as described below.

In some demonstrative aspects, controller 124 may be configured to control, trigger, cause, and/or instruct the STA implemented by device 102 to configure a Medium Access Control (MAC) pre-FEC padding boundary for the PPDU, for example, based on the pre-FEC padding factor value, e.g., as described below.

In some demonstrative aspects, controller 124 may be configured to control, trigger, cause, and/or instruct the STA implemented by device 102 to encode the data field of the PPDU according to the FEC coding based on the MAC pre-FEC padding boundary, e.g., as described below.

In some demonstrative aspects, the MAC pre-FEC padding boundary may include a number of symbol segments, e.g., in the range between 1 and 2Na, for MAC pre-FEC padding in the last OFDM symbol of the PPDU, e.g., as described below.

In some demonstrative aspects, controller 124 may be configured to control, trigger, cause, and/or instruct the STA implemented by device 102 to determine a number of pre-FEC padding bits, for example, based on the pre-FEC padding factor value, e.g., as described below.

In some demonstrative aspects, controller 124 may be configured to control, trigger, cause, and/or instruct the STA implemented by device 102 to determine the number of pre-FEC padding bits, for example, based on the pre-FEC padding factor value and a packet size of the data field, e.g., as described below.

In some demonstrative aspects, controller 124 may be configured to control, trigger, cause, and/or instruct the STA implemented by device 102 to encode the data field of the PPDU according to the FEC coding using the number of pre-FEC padding bits, e.g., as described below.

In some demonstrative aspects, controller 124 may be configured to control, trigger, cause, and/or instruct the STA implemented by device 102 to determine a number of data bits for the last OFDM symbol of the PPDU, for example, based on the pre-FEC padding factor value, e.g., as described below.

In some demonstrative aspects, controller 124 may be configured to control, trigger, cause, and/or instruct the STA implemented by device 102 to encode the data field of the PPDU based on the number of data bits for the last OFDM symbol of the PPDU, e.g., as described below.

In some demonstrative aspects, controller 124 may be configured to control, trigger, cause, and/or instruct the STA implemented by device 102 to encode the data field of the PPDU, for example, based on the number of data bits for the last OFDM symbol of the PPDU and a total number of data bits in non-last OFDM symbols of the PPDU, e.g., as described below.

In some demonstrative aspects, controller 124 may be configured to control, trigger, cause, and/or instruct the STA implemented by device 102 to determine a total number of bits in a PHY Service Data Unit (PSDU) and service field, for example, based on the number of data bits for the last OFDM symbol of the PPDU, e.g., as described below.

In some demonstrative aspects, controller 124 may be configured to control, trigger, cause, and/or instruct the STA implemented by device 102 to encode the data field of the PPDU, for example, based on the total number of bits in the PSDU and the service field, e.g., as described below.

In some demonstrative aspects, controller 124 may be configured to control, trigger, cause, and/or instruct the STA implemented by device 102 to determine the pre-FEC padding factor value including an initial pre-FEC padding factor value, e.g., as described below.

In some demonstrative aspects, controller 124 may be configured to control, trigger, cause, and/or instruct the STA implemented by device 102 to determine the number of data bits for the last OFDM symbol of the PPDU including a number of data bits for the last OFDM symbol for a u-th user, e.g., as follows:

$${N}_{DBPS , last , init , u} = \{ \begin{matrix}{a}_{init} \cdot {N}_{DBPS , short , u} & if {a}_{init} < {2}^{{N}_{a}} \\ {N}_{DBPS , u} & if {a}_{init} = {2}^{{N}_{a}}\end{matrix}$$

wherein N_{DBPS,last,init,u} denotes the number of data bits for the last OFDM symbol for the u-th user, wherein aᵢₙᵢₜ denotes the initial pre-FEC padding factor value, wherein N_{DBPS,u} denotes a number of data bits per OFDM symbol for the u-th user, and wherein N_{DBPS,short,u} denotes a short number of data bits per OFDM symbol for the u-th user, e.g., as described below.

In some demonstrative aspects, controller 124 may be configured to control, trigger, cause, and/or instruct the STA implemented by device 102 to determine the initial pre-FEC padding factor value for the u-th user, e.g., as follows:

$${a}_{init , u} = \{ \begin{matrix}{2}^{{N}_{a}} , & if {N}_{Excess , u} = 0 \\ min ( [ \frac{{N}_{Excess , u}}{{N}_{DBPS , short , u}} ] , {2}^{{N}_{a}} ) , & otherwise\end{matrix}$$

wherein a_{init,u} denotes the initial pre-FEC padding factor value for the u-th user,
wherein N_{Excess,u} denotes a number of data bits left in a last OFDM symbol for the u-th user, and wherein N_{DBPS,short,u} denotes a short number of data bits per OFDM symbol for the u-th user.

In some demonstrative aspects, controller 124 may be configured to control, trigger, cause, and/or instruct the STA implemented by device 102 to set another bit in the SIG field, e.g., other than the Na bits, for example, such that a combination of the Na bits and the other bit is to indicate a MAC pre-FEC padding boundary for the PPDU, e.g., as described below.

In some demonstrative aspects, the other bit in the SIG field may include a bit representing an LDPC extra symbol segment subfield, e.g., as described below.

In some demonstrative aspects, the other bit in the SIG field may include a bit representing an LDPC extra symbol subfield, e.g., as described below.

In other aspects, the other bit may include any other suitable bit in the SIG field.

In some demonstrative aspects, controller 124 may be configured to control, trigger, cause, and/or instruct the STA implemented by device 102 to configure the FEC coding based on the pre-FEC padding factor value, for example, such that no post-FEC padding is to be applied for the PPDU, for example, according to the third FEC padding technique, e.g., as described below.

In some demonstrative aspects, controller 124 may be configured to control, trigger, cause, and/or instruct the STA implemented by device 102 to determine a post FEC (post-FEC) padding factor value for the PPDU, for example, according to the second FEC padding technique, e.g., as described below.

In some demonstrative aspects, controller 124 may be configured to control, trigger, cause, and/or instruct the STA implemented by device 102 to determine the post-FEC padding factor value in a range between 1 and 2^{Nb}, wherein Nb is equal to or greater than 0, e.g., as described below.

In some demonstrative aspects, controller 124 may be configured to control, trigger, cause, and/or instruct the STA implemented by device 102 to encode the data field of the PPDU according to the FEC coding based on the post-FEC padding factor value, e.g., as described below.

In some demonstrative aspects, controller 124 may be configured to control, trigger, cause, and/or instruct the STA implemented by device 102 to determine the post-FEC padding factor value, for example, based on the pre-FEC padding factor value and a ratio between 2^{Na} and 2^{Nb} (2^{Na}/2^{Nb}), e.g., as described below.

In other aspects, controller 124 may be configured to control, trigger, cause, and/or instruct the STA implemented by device 102 to determine the post-FEC padding factor value based on any other suitable additional or alternative criteria, parameter and/or calculation.

In some demonstrative aspects, controller 124 may be configured to control, trigger, cause, and/or instruct the STA implemented by device 102 to determine the post-FEC padding factor value based on the value Nb=0, e.g., as described below.

In some demonstrative aspects, controller 124 may be configured to control, trigger, cause, and/or instruct the STA implemented by device 102 to determine the post-FEC padding factor value based on the value Nb=1, e.g., as described below.

In some demonstrative aspects, controller 124 may be configured to control, trigger, cause, and/or instruct the STA implemented by device 102 to determine the post-FEC padding factor value based on the value Nb=Na, e.g., as described below.

In some demonstrative aspects, controller 124 may be configured to control, trigger, cause, and/or instruct the STA implemented by device 102 to determine the post-FEC padding factor value based on the value Nb different from the value Na, e.g., as described below.

In some demonstrative aspects, controller 124 may be configured to control, trigger, cause, and/or instruct the STA implemented by device 102 to determine a number of coded bits for the last OFDM symbol of the PPDU, for example, based on the post-FEC padding factor value, e.g., as described below.

In some demonstrative aspects, controller 124 may be configured to control, trigger, cause, and/or instruct the STA implemented by device 102 to encode the data field of the PPDU based on the number of coded bits for the last OFDM symbol of the PPDU, e.g., as described below.

In some demonstrative aspects, controller 124 may be configured to control, trigger, cause, and/or instruct the STA implemented by device 102 to encode the data field of the PPDU based on the number of coded bits for the last OFDM symbol of the PPDU and the total number of bits in the non-last OFDM symbols of the PPDU, e.g., as described below.

In some demonstrative aspects, controller 124 may be configured to control, trigger, cause, and/or instruct the STA implemented by device 102 to determine a number of available bits for the data field, for example, based on the number of coded bits for the last OFDM symbol of the PPDU, e.g., as described below.

In some demonstrative aspects, controller 124 may be configured to control, trigger, cause, and/or instruct the STA implemented by device 102 to encode the data field of the PPDU, for example, based on the number of available bits for the data field, e.g., as described below.

In some demonstrative aspects, controller 124 may be configured to control, trigger, cause, and/or instruct the STA implemented by device 102 to set the Na bits in the SIG field, for example, to indicate both the pre-FEC padding factor value and the post-FEC padding factor value, e.g., as described below.

In other aspects, controller 124 may be configured to control, trigger, cause, and/or instruct the STA implemented by device 102 to set the Na bits in the SIG field to indicate the pre-FEC padding factor value, and to set one or more other bits in the SIG field to indicate the post-FEC padding factor value.

In some demonstrative aspects, controller 124 may be configured to control, trigger, cause, and/or instruct the STA implemented by device 102 to determine a pre-FEC padding factor value for a PPDU, and to determine a post-FEC padding factor value for the PPDU, for example, according to the second FEC padding technique, e.g., as described below.

In some demonstrative aspects, controller 124 may be configured to control, trigger, cause, and/or instruct the STA implemented by device 102 to determine the post-FEC padding factor value in a range between 1 and 2Nb, wherein Nb is an integer equal to or greater than 0, e.g., as described below.

In some demonstrative aspects, controller 124 may be configured to control, trigger, cause, and/or instruct the STA implemented by device 102 to set a plurality of bits in a SIG field of the PPDU to indicate the pre-FEC padding factor value and the post-FEC padding factor value, e.g., as described below.

In some demonstrative aspects, controller 124 may be configured to control, trigger, cause, and/or instruct the STA implemented by device 102 to encode a data field of the PPDU according to a FEC coding based on the pre-FEC padding factor value and the post-FEC padding factor value, e.g., as described below.

In some demonstrative aspects, the value of Nb may correspond to, and/or may represent, a granularity of the post-FEC padding factor value, e.g., as described below.

In some demonstrative aspects, the value of Nb may correspond to, and/or may represent, a granularity level of possibilities to set the PHY boundary, e.g., as described below. For example, a higher value of Nb may correspond to, and/or may represent, a higher granularity level of possibilities to set the PHY boundary. In one example, value of Nb=2 may correspond to, and/or may represent, a granularity of 1/(22)=1/4 of an OFDM symbol for setting the PHY boundary. In another example, value of Nb=3 may correspond to, and/or may represent, a granularity of 1/(23)=1/8 of an OFDM symbol for setting the PHY boundary.

In some demonstrative aspects, the FEC coding may include an LDPC coding, e.g., as described below.

In other aspects, the FEC coding may include any other additional or alternative suitable type of FEC coding.

In some demonstrative aspects, controller 124 may be configured to control, trigger, cause, and/or instruct the STA implemented by device 102 to set the plurality of bits in the SIG field of the PPDU, for example, such that a combination of the plurality of bits is to indicate the pre-FEC padding factor value, e.g., as described below.

In some demonstrative aspects, controller 124 may be configured to control, trigger, cause, and/or instruct the STA implemented by device 102 to set the plurality of bits in the SIG field of the PPDU, for example, such that one or more predefined bits of the plurality of bits is to indicate the post-FEC padding factor value, e.g., as described below.

In some demonstrative aspects, the PPDU may include a MU PPDU for a plurality of users, e.g., as described below.

In some demonstrative aspects, controller 124 may be configured to control, trigger, cause, and/or instruct the STA implemented by device 102 to determine the pre-FEC padding factor value to include a common pre-FEC padding factor value to be applied for all users in the plurality of users, e.g., as described below.

In other aspects, the PPDU may include a SU PPDU for a single user, e.g., as described below.

In some demonstrative aspects, controller 124 may be configured to control, trigger, cause, and/or instruct the STA implemented by device 102 to determine the post-FEC padding factor value based on the value Nb=0, e.g., as described below.

In some demonstrative aspects, controller 124 may be configured to control, trigger, cause, and/or instruct the STA implemented by device 102 to determine the post-FEC padding factor value based on the value Nb=1, e.g., as described below.

In other aspects, controller 124 may be configured to control, trigger, cause, and/or instruct the STA implemented by device 102 to determine the post-FEC padding factor value based on any other suitable value of Nb, e.g., as described below.

In some demonstrative aspects, controller 124 may be configured to control, trigger, cause, and/or instruct the STA implemented by device 102 to determine the post-FEC padding factor value based on the value Nb=Na, e.g., as described below.

In some demonstrative aspects, controller 124 may be configured to control, trigger, cause, and/or instruct the STA implemented by device 102 to determine the post-FEC padding factor value to be equal to the pre-FEC padding factor value, e.g., as described below.

In some demonstrative aspects, controller 124 may be configured to control, trigger, cause, and/or instruct the STA implemented by device 102 to determine the post-FEC padding factor value based on the value Nb different from the value Na, e.g., as described below.

In some demonstrative aspects, controller 124 may be configured to control, trigger, cause, and/or instruct the STA implemented by device 102 to determine the post-FEC padding factor value to be different from the pre-FEC padding factor value, e.g., as described below.

In some demonstrative aspects, controller 124 may be configured to control, trigger, cause, and/or instruct the STA implemented by device 102 to determine the post-FEC padding factor value, for example, based on the pre-FEC padding factor value, e.g., as described below.

In some demonstrative aspects, controller 124 may be configured to control, trigger, cause, and/or instruct the STA implemented by device 102 to determine a number of coded bits for a last OFDM symbol of the PPDU, for example, based on the post-FEC padding factor value, e.g., as described below.

In some demonstrative aspects, controller 124 may be configured to control, trigger, cause, and/or instruct the STA implemented by device 102 to encode the data field of the PPDU based on the number of coded bits for the last OFDM symbol of the PPDU, e.g., as described below.

In some demonstrative aspects, controller 124 may be configured to control, trigger, cause, and/or instruct the STA implemented by device 102 to encode the data field of the PPDU based on the number of coded bits for the last OFDM symbol of the PPDU and a total number coded bits for non-last OFDM symbols of the PPDU, e.g., as described below.

In some demonstrative aspects, controller 124 may be configured to control, trigger, cause, and/or instruct the STA implemented by device 102 to determine a number of available bits for the data field, for example, based on the number of coded bits for the last OFDM symbol of the PPDU, e.g., as described below.

In some demonstrative aspects, controller 124 may be configured to control, trigger, cause, and/or instruct the STA implemented by device 102 to determine a number of available bits for the data field, for example, based on the number of coded bits for the last OFDM symbol of the PPDU and the total number coded bits for non-last OFDM symbols of the PPDU, e.g., as described below.

In some demonstrative aspects, controller 124 may be configured to control, trigger, cause, and/or instruct the STA implemented by device 102 to encode the data field of the PPDU, for example, based on the number of available bits for the data field, e.g., as described below.

In some demonstrative aspects, controller 124 may be configured to control, trigger, cause, and/or instruct the STA implemented by device 102 to determine the post-FEC padding factor value including an initial post-FEC padding factor value, e.g., as described below.

In some demonstrative aspects, controller 124 may be configured to control, trigger, cause, and/or instruct the STA implemented by device 102 to determine the number of coded bits for the last OFDM symbol of the PPDU including a number of coded bits for the last OFDM symbol for a u-th user, e.g., as follows:

$${N}_{CBPS , last , init , u} = \{ \begin{matrix}{b}_{init} \cdot {N}_{CBPS , short , u} & if {b}_{init} < {2}^{{N}_{b}} \\ {N}_{CBPS , u} & if {b}_{init} = {2}^{{N}_{b}}\end{matrix}$$

wherein N_{CBPS,last,init,u} denotes the number of coded bits for the last OFDM symbol for the u-th user, wherein bᵢₙᵢₜ denotes the initial post-FEC padding factor value, wherein N_{CBPS,u} denotes a number of coded bits per OFDM symbol for the u-th user, and wherein N_{CBPS,short,u} denotes a short number of coded bits per OFDM symbol for the u-th user, e.g., as described below.

In some demonstrative aspects, controller 124 may be configured to control, trigger, cause, and/or instruct the STA implemented by device 102 to determine the initial post-FEC padding factor value, e.g., as follows:

$${b}_{init} = ⌈ \frac{{a}_{init}}{{2}^{{N}_{a}} / {2}^{{N}_{b}}} ⌉$$

wherein bᵢₙᵢₜ denotes the initial post-FEC padding factor value, and wherein bᵢₙᵢₜ denotes the initial pre-FEC padding factor value, wherein aᵢₙᵢₜ is in a range between 1 and 2Na, e.g., as described below.

In some demonstrative aspects, controller 124 may be configured to control, trigger, cause, and/or instruct the STA implemented by device 102 to determine a pre-FEC padding factor value for a PPDU, and to encode a data field of the PPDU according to a FEC coding based on the pre-FEC padding factor value and based on a condition that no post-FEC padding is to be applied for the PPDU, for example, according to the third FEC padding technique, e.g., as described below.

In some demonstrative aspects, controller 124 may be configured to control, trigger, cause, and/or instruct the STA implemented by device 102 to set an LDPC extra symbol subfield in a Signal (SIG) field of the PPDU, for example, to indicate whether or not an LDPC extra symbol is present based on encoding of the data field of the PPDU, e.g., as described below.

In some demonstrative aspects, controller 124 may be configured to control, trigger, cause, and/or instruct the STA implemented by device 102 to determine a number of available bits for the data field of the PPDU, for example, based on the condition that no post-FEC padding is to be applied, e.g., as described below.

In some demonstrative aspects, the FEC coding may include an LDPC coding, e.g., as described below.

In other aspects, the FEC coding may include any other additional or alternative suitable type of FEC coding.

In some demonstrative aspects, the PPDU may include a MU PPDU for a plurality of users, e.g., as described below.

In some demonstrative aspects, controller 124 may be configured to control, trigger, cause, and/or instruct the STA implemented by device 102 to configure the encoding of the data field of the PPDU according to the FEC coding, for example, such that a common number of OFDM symbols is to be applied for all users in the plurality of users, e.g., as described below.

In other aspects, the PPDU may include an SU PPDU for a single user, e.g., as described below.

In some demonstrative aspects, the LDPC extra symbol subfield may include a single-bit subfield in the SIG field, e.g., as described below.

In some demonstrative aspects, the LDPC extra symbol subfield may include, for example, a bit B9 of a common information field in the SIG field, e.g., as described below.

In some demonstrative aspects, controller 124 may be configured to control, trigger, cause, and/or instruct the STA implemented by device 102 to set the LDPC extra symbol subfield to a value of “1” or a value of “0”, e.g., as described below.

In some demonstrative aspects, the LDPC extra symbol subfield may be set to the value of “1”, for example, to indicate that an LDPC extra symbol is present, e.g., as described below.

In some demonstrative aspects, the LDPC extra symbol subfield may be set to the value of “0”, for example, to indicate that an LDPC extra symbol is not present, e.g., as described below.

In other aspects, the LDPC extra symbol subfield may configured to include any other single bit or multiple bits of the SIG field.

In some demonstrative aspects, controller 124 may be configured to control, trigger, cause, and/or instruct the STA implemented by device 102 to encode the data field of the PPDU, for example, such that a PHY boundary for the PPDU is independent of the pre-FEC padding factor value, e.g., as described below.

In some demonstrative aspects, controller 124 may be configured to control, trigger, cause, and/or instruct the STA implemented by device 102 to encode the data field of the PPDU, for example, such that the PHY boundary for the PPDU is equal to a number of OFDM symbols for the PPDU, e.g., as described below.

In other aspects, controller 124 may be configured to control, trigger, cause, and/or instruct the STA implemented by device 102 to encode the data field of the PPDU based on any other additional or alternative condition or criteria related to the PHY boundary for the PPDU.

In some demonstrative aspects, controller 124 may be configured to control, trigger, cause, and/or instruct the STA implemented by device 102 to determine a duration of a Packet Extension (PE) field in the PPDU, for example, independent of the pre-FEC padding factor value, e.g., as described below.

In some demonstrative aspects, controller 124 may be configured to control, trigger, cause, and/or instruct the STA implemented by device 102 to determine a number of available bits for the data field of the PPDU, e.g., as described below.

In some demonstrative aspects, controller 124 may be configured to control, trigger, cause, and/or instruct the STA implemented by device 102 to encode the data field of the PPDU based on the number of available bits for the data field of the PPDU, e.g., as described below.

In some demonstrative aspects, controller 124 may be configured to control, trigger, cause, and/or instruct the STA implemented by device 102 to set the LDPC extra symbol subfield, for example, based on whether the number of available bits for the data field of the PPDU is determined according to a first predefined calculation or a second predefined calculation, e.g., as described below.

In some demonstrative aspects, controller 124 may be configured to control, trigger, cause, and/or instruct the STA implemented by device 102 to determine which predefined calculation is to be used for determination of the number of available bits for the data field of the PPDU, for example, based on at least one predefined criterion, e.g., as described below.

In some demonstrative aspects, controller 124 may be configured to control, trigger, cause, and/or instruct the STA implemented by device 102 to select, e.g., from a plurality of predefined calculations, the predefined calculation to be used for determination of the number of available bits for the data field of the PPDU, for example, based on the at least one predefined criterion, e.g., as described below.

In some demonstrative aspects, controller 124 may be configured to control, trigger, cause, and/or instruct the STA implemented by device 102 to determine whether the first predefined calculation or the second predefined calculation is to be used for determination of the number of available bits for the data field of the PPDU, for example, based on the at least one predefined criterion, e.g., as described below.

In some demonstrative aspects, controller 124 may be configured to control, trigger, cause, and/or instruct the STA implemented by device 102 to determine to use the first predefined calculation for determination of the number of available bits for the data field of the PPDU, for example, based on a determination that a predefined criterion is not met, e.g., as described below.

In some demonstrative aspects, controller 124 may be configured to control, trigger, cause, and/or instruct the STA implemented by device 102 to determine to use the second predefined calculation for determination of the number of available bits for the data field of the PPDU, for example, based on a determination that the predefined criterion is met, e.g., as described below.

In some demonstrative aspects, the predefined criterion may relate to one or more LDPC encoding parameters calculated during the FEC encoding, e.g., as described below.

In other aspects, the predefined criterion may relate to any other additional or alternative parameters.

In some demonstrative aspects, controller 124 may be configured to control, trigger, cause, and/or instruct the STA implemented by device 102 to determine the number of available bits for the data field of the PPDU according to the first predefined calculation, which may include, for example, a calculation of a number of available bits for a u-th user, e.g., as follows:

N_{avbits,u}=N_{SYM,init}N_{CBPS,u}

wherein N_{avbits,u} denotes the number of available bits for the u-th user, wherein N_{SYM,init} denotes an initial number of OFDM symbols, and wherein N_{CBPS,u} denotes a number of coded bits per OFDM symbol for the u-th user, e.g., as described below.

In some demonstrative aspects, controller 124 may be configured to control, trigger, cause, and/or instruct the STA implemented by device 102 to set the LDPC extra symbol subfield to a value of “0”, for example, based on use of the first predefined calculation for determination of the number of available bits for the data field of the PPDU, e.g., as described below.

In some demonstrative aspects, controller 124 may be configured to control, trigger, cause, and/or instruct the STA implemented by device 102 to determine that a predefined criterion applied to one or more LDPC encoding parameters calculated during the FEC encoding is not met; and, for example, based on the determination that the predefined criterion is note met, to set the LDPC extra symbol subfield to the value of “0”, and to determine the number of available bits for the data field of the PPDU according to the first predefined calculation, e.g., as described below.

In some demonstrative aspects, controller 124 may be configured to control, trigger, cause, and/or instruct the STA implemented by device 102 to determine the number of available bits for the data field of the PPDU according to the second predefined calculation, which may include, for example, a calculation of a number of available bits for a u-th user, e.g., as follows:

N_{avbits,u}=N_{SYM,init}N_{CBPS,u}+N_{CBPS,u}

wherein N_{avbits,u} denotes the number of available bits for the u-th user, wherein N_{SYM,init} denotes an initial number of OFDM symbols, and wherein N_{CBPS,u} denotes a number of coded bits per OFDM symbol for the u-th user, e.g., as described below.

In some demonstrative aspects, controller 124 may be configured to control, trigger, cause, and/or instruct the STA implemented by device 102 to set the LDPC extra symbol subfield to a value of “1”, for example, based on use of the second predefined calculation for determination of the number of available bits for the data field of the PPDU, e.g., as described below.

In some demonstrative aspects, controller 124 may be configured to control, trigger, cause, and/or instruct the STA implemented by device 102 to determine that the predefined criterion applied to the one or more LDPC encoding parameters calculated during the FEC encoding is met; and, for example, based on the determination that the predefined criterion is met, to set the LDPC extra symbol subfield to the value of “1”, and to determine the number of available bits for the data field of the PPDU according to the second predefined calculation, e.g., as described below.

In some demonstrative aspects, device 102, device 140, and/or device 160 may be configured to implement one or more operations and/or functionalities of a PPDU padding process to pad a data field of a PPDU, e.g., as described below.

In some demonstrative aspects, device 102, device 140, and/or device 160 may be configured to implement one or more operations and/or functionalities of a UHR PPDU padding process to pad a data field of a UHR PPDU, e.g., as described below.

In some demonstrative aspects, the UHR PPDU padding process may include a UHR SU PPDU padding process, which may be configured to pad a data field of a UHR SU PPDU, e.g., as described below.

In some demonstrative aspects, the UHR PPDU padding process may include a UHR MU PPDU padding process, which may be configured to pad a data field of a UHR MU PPDU, e.g., as described below.

In other aspects, the PPDU padding process may be configured to pad any other suitable additional or alternative type of PPDU.

In some demonstrative aspects, the UHR PPDU padding process may be configured according to the first FEC padding technique utilizing an increased pre-FEC padding factor, e.g., as described below.

In some demonstrative aspects, additionally or alternatively, the UHR PPDU padding process may be configured according to the second FEC padding technique utilizing a post-FEC padding factor, e.g., as described below.

In some demonstrative aspects, additionally or alternatively, the UHR PPDU padding process may be configured according to the third FEC padding technique, which may be configured based on a condition that no post-FEC padding is to be applied for an encoded UHR PPDU, e.g., as described below.

In some demonstrative aspects, the UHR PPDU padding process may be configured for an LDPC coding of at least part of the UHR PPDU, e.g., as described below.

In some demonstrative aspects, the UHR PPDU padding process may be configured to support an LDPC coding to be applied for one or more users, e.g., some or all users, of a UHR MU PPDU, e.g., as described below.

In some demonstrative aspects, the UHR PPDU padding process may be configured to support a Binary Convolution Code (BCC) coding to be applied for one or more users of the UHR MU PPDU, e.g., as described below.

In other aspects, the UHR PPDU padding process may be configured to support any other suitable FEC coding to applied for one or more users of the UHR MU PPDU, e.g., as described below.

In some demonstrative aspects, the UHR PPDU padding process may be configured to support LDPC coding with an LDPC codeword length selected from a plurality of, e.g., all available, codeword lengths, for example, codeword lengths of 648, 1296, 1944, 3888, 7666, and/or any other suitable codeword lengths, to be used in the PPDU encoding process.

In some demonstrative aspects, the UHR PPDU padding process may be configured to utilize a pre-FEC padding process, which may be applied, for example, before conducting FEC coding, for example, in accordance with an IEEE 802.11ax Specification and/or an IEEE 802.11be Specification, e.g., as described below.

In some demonstrative aspects, the UHR PPDU padding process may be configured to utilize a post-FEC padding process, which may be applied, for example, on the FEC encoded bits after conducting FEC coding, for example, in accordance with an IEEE 802.11ax Specification and/or an IEEE 802.11be Specification, e.g., as described below.

In some demonstrative aspects, the UHR PPDU padding process may be configured to exclude and/or remove the post-FEC padding, for example, by replacing any one or more, e.g., some or all, post-FEC padding bits with repetition bits, e.g., as described below.

In some demonstrative aspects, the UHR PPDU padding process may be configured to provide a technical solution to support an increased number of pre-FEC padding boundaries (also referred to as “MAC boundaries”), for example, more than four MAC boundaries, e.g., as described below.

In some demonstrative aspects, configuring the UHR PPDU padding process to support an increased number of pre-FEC boundaries, e.g., more than 4 MAC boundaries, may provide a technical solution to further reduce a number of pre-FEC padding bits, e.g., as described below.

In some demonstrative aspects, the UHR PPDU padding process may be configured as a UHR MU PPDU padding process, which may be applied for transmission of a UHR MU PPDU to multiple users, e.g., as described below.

In some demonstrative aspects, the UHR MU PPDU padding process may be applied to a UHR SU PPDU for a UHR SU transmission to a single user, e.g., as described below.

For example, the UHR MU PPDU padding process may be applied to a UHR SU PPDU, for example, by using a user index u=1, and a total number of users N_{user,total}=1, e.g., as described below.

In some demonstrative aspects, the UHR MU PPDU padding process may be configured, for example, such that a common value of the pre-FEC padding factor a and a common value of the number of OFDM symbols N_{SYM} is to be applied for all users of the MU PPDU, e.g., as described below.

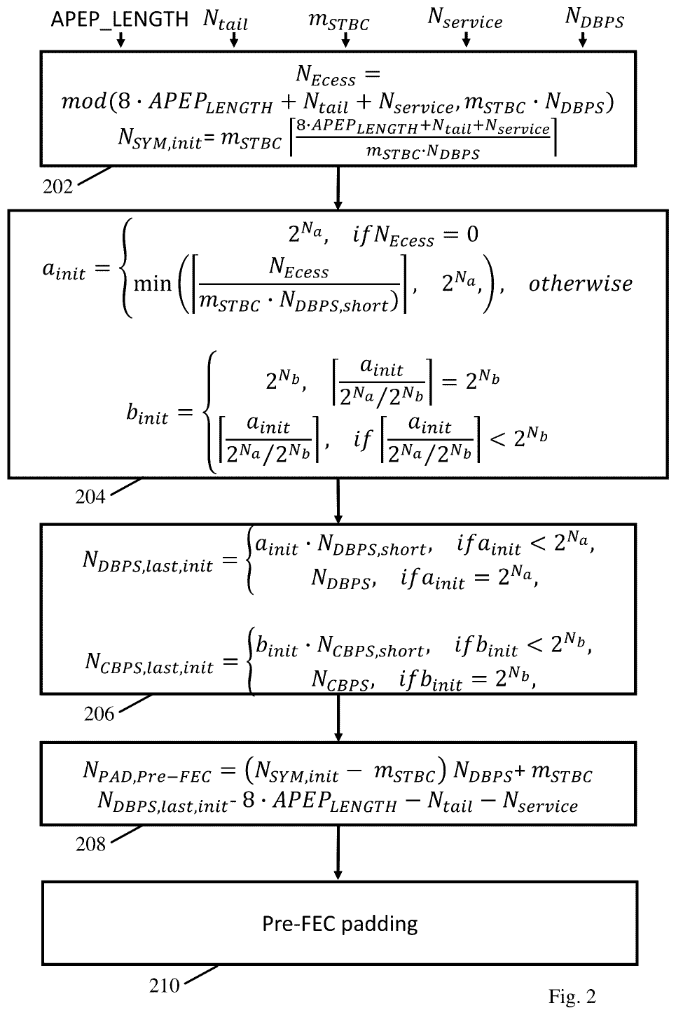

Reference is made to FIG. 2, which illustrates a method of pre-FEC padding, in accordance with some demonstrative aspects.

For example, device 102 (FIG. 1), device 140 (FIG. 1), and/or device 160 (FIG. 1) may implement one or more operations of the method of FIG. 2. For example, controller 124 may be configured to control, trigger, cause, and/or instruct a STA implemented by device 102 to perform one or more operations of the method of FIG. 2.

In some demonstrative aspects, the method of FIG. 2 may be configured to support a padding process for a SU PPDU, e.g., as described below.

In some demonstrative aspects, one or more of the operations of the method of FIG. 2 may be extended, for example, to support a padding process for a MU PPDU, e.g., as described below.

In some demonstrative aspects, the method of FIG. 2 may be configured as an enhanced pre-FEC padding process, e.g., as described below.

In some demonstrative aspects, the method of FIG. 2 may be configured, for example, as an enhancement of a pre-FEC padding process, e.g., in accordance with an IEEE 802.11 Specification.

In some demonstrative aspects, the method of FIG. 2 may be configured according to the first FEC padding technique utilizing an increased pre-FEC padding factor, denoted a, which is greater than 4, e.g., as described below.

In some demonstrative aspects, the method of FIG. 2 may be configured according to the second FEC padding technique utilizing a post-FEC padding factor, denoted b, e.g., as described below.

In some demonstrative aspects, as indicated at block 202, the method may include determining a number of bits, denoted N_{Excess}, which are left in a last OFDM symbol for a data field, e.g., a PSDU, of a PPDU, e.g., as follows:

$${N}_{Excess} = mod ( 8 \cdot APEP\_LENGTH + {N}_{tail} + {N}_{service} , {m}_{STBC} \cdot {N}_{DBPS} )$$

wherein:
m_{STBC} is 2 if Space Time Block Code (STBC) is used, and 1 otherwise;
APEP_LENGTH (also denoted APPEP_{LENGTH}) denotes a transmit vector (TXVECTOR) parameter APEP_LENGTH, e.g., representing a number of octets in an Aggregate MPDU (A-MPDU) per End of Field (per-EOF) padding that is carried in a PSDU;
Nₜₐᵢₗ denotes a number of tail bits per encoder;
N_{service} denotes a number of bits in a SERVICE field;
N_{DBPS} denotes a number of data bits per OFDM symbol.

In some demonstrative aspects, as indicated at block 202, the method may include determining an initial number of data OFDM symbols with encoding, denoted N_{SYM,init}, e.g., as follows:

$${N}_{SYM , init} = {m}_{STBC} ⌈ \frac{8 \cdot APEP\_LENGTH + {N}_{tail} + {N}_{service}}{{m}_{STBC} \cdot {N}_{DBPS}} ⌉$$

In some demonstrative aspects, as indicated at block 204, the method may include determining an initial pre-FEC padding factor value, denoted aᵢₙᵢₜ, e.g., as follows:

$${a}_{init} = \{ \begin{matrix}{2}^{Na} , if {N}_{Excess} = 0 \\ min ( ⌈ \frac{{N}_{Excess}}{{m}_{STBC} \cdot {N}_{DBPSs , short} )} ⌉ , {2}^{Na} ) , otherwise\end{matrix}$$

wherein:
Na is an integer greater than 2;
N_{DBPS}, short denotes a short number of data bits per OFDM symbol, which may be defined, for example, based on the value of Na.

In some demonstrative aspects, as indicated at block 204, the method may include determining an initial post-FEC padding factor value, denoted bᵢₙᵢₜ, e.g., as follows:

$${b}_{init} = \{ \begin{matrix}{2}^{Nb} , if ⌈ \frac{{a}_{init}}{{2}^{{N}_{a}} / {2}^{{N}_{b}}} ⌉ = {2}^{Nb} \\ ⌈ \frac{{a}_{init}}{{2}^{{N}_{a}} / {2}^{{N}_{b}}} ⌉ , if ⌈ \frac{{a}_{init}}{{2}^{{N}_{a}} / {2}^{{N}_{b}}} ⌉ < {2}^{Nb}\end{matrix}$$

wherein:
Nb is an integer equal to or greater than 0.

In some demonstrative aspects, the value of Na=3 may be used.

In other aspects, any other value of Na>2 may be used.

In some demonstrative aspects, the value of Nb=0 may be used.

In some demonstrative aspects, the value of Nb=1 may be used.

In some demonstrative aspects, the value of Nb=2 may be used.

In other aspects, any other values of Na and/or Nb may be used.

In some demonstrative aspects, as indicated at block 206, the method may include determining an initial number of data bits per symbol in the last OFDM symbol, denoted N_{DBPS,last,init}, for example, based on the initial pre-FEC padding factor value aᵢₙᵢₜ, e.g., as follows:

$${N}_{DBPS , last , init} = \{ \begin{matrix}{a}_{init} \cdot {N}_{DPBS , short} , if {a}_{init} < {2}^{Na} \\ {N}_{DBPS} , if {a}_{init} = {2}^{Na}\end{matrix}$$

In some demonstrative aspects, as indicated at block 206, the method may include determining an initial number of coded bits per symbol in the last OFDM symbol, denoted N_{CBPS,last,init}, for example, based on the initial post-FEC padding factor value bᵢₙᵢₜ, e.g., as follows:

$${N}_{CBPS , last , init} = \{ \begin{matrix}{b}_{init} \cdot {N}_{CBPS , short} , if {b}_{init} < {2}^{Nb} \\ {N}_{CBPS} , if {b}_{init} = {2}^{Nb}\end{matrix}$$

In some demonstrative aspects, as indicated at block 208, the method may include determining a number of pre-FEC pad bits, denoted N_{PAD,Pre-FEC}, for example, as follows:

$${N}_{PAD , Pre - FEC} = ( {N}_{SYM , init} - {m}_{STBC} ) {N}_{DBPS} + {m}_{STBC} {N}_{DBPS , last , init} - 8 \cdot APEP\_LENGTH - {N}_{tail} - {N}_{service}$$

In some demonstrative aspects, as indicated at block 210, the method may include performing pre-FEC padding, for example, based on the number of pre-FEC pad bits N_{PAD,Pre-FEC}.

Referring back to FIG. 1, in some demonstrative aspects, device 102, device 140, and/or device 160 may be configured to implement one or more operations and/or functionalities of a UHR MU PPDU padding process to pad a data field of a UHR MU PPDU, e.g., as described below.

In some demonstrative aspects, the UHR MU PPDU padding process may be configured according to the first FEC padding technique utilizing a pre-FEC padding factor a=2^{Na}, e.g., as described below.

In some demonstrative aspects, additionally or alternatively, the UHR MU PPDU padding process may be configured according to the second FEC padding technique utilizing a post-FEC padding factor b=2^{Nb}, e.g., as described below.

In some demonstrative aspects, additionally or alternatively, the UHR MU PPDU padding process may be configured according to the third FEC padding technique, which may be configured based on a condition that no post-FEC padding is to be applied for an encoded UHR MU PPDU, for example, by setting the value of Nb=0, e.g., as described below.

In some demonstrative aspects, the UHR MU PPDU padding process may be applied to a UHR SU PPDU for a UHR SU transmission to a single user, e.g., as described below.

For example, the UHR MU PPDU padding process may be applied to a UHR SU PPDU, for example, by using a user index u=1, and a total number of users N_{user,total}=1, e.g., as described below.

In some demonstrative aspects, the UHR MU PPDU padding process may be configured, for example, such that a common value of the pre-FEC padding factor a and a common value of the number of OFDM symbols N_{SYM} is to be applied for all users of the MU PPDU, e.g., as described below.

In some demonstrative aspects, it may be defined according to the UHR MU PPDU padding process that in an UHR MU PPDU transmission, the transmitter first computes the number of data bits left in the last OFDM symbol for user u, e.g., as follows:

$${N}_{Excess , u} = ( 8 \cdot {APEP\_LENGTH}_{u} + {N}_{tail , u} + {N}_{service} ) mod {N}_{DBPS , u}$$

wherein:
APEP_LENGTHᵤ is the TXVECTOR parameter APEP_LENGTH for the u-th user,
N_{tail,u} is the number of tails bits per encoder for user u,
N_{service} is the number of bits in the SERVICE field, and
N_{DBPS,u} is the number of data bits per OFDM symbol for the u-th user.

In some demonstrative aspects, it may be defined according to the UHR MU PPDU padding process that, for example, based on N_{Excess},u, the transmitter then computes the initial number of symbol segments in the last OFDM symbol, (“the initial pre-FEC factor value a_{init,u}”), and the initial number of OFDM symbols, N_{SYM,init,u}>for the user u, e.g., as follows:

$${a}_{init , u} = \{ \begin{matrix}{2}^{{N}_{a}} , & if {N}_{Excess , u} = 0 \\ min ( [ \frac{{N}_{Excess , u}}{{N}_{DBPS , short , u}} ] , {2}^{{N}_{a}} ) , & otherwise\end{matrix} \\ {N}_{SYM , init , u} = ⌈ \frac{{APEP\_LENGTH}_{u} \times 8 + {N}_{tail , u} + {N}_{service}}{{N}_{DBPS , u}} ⌉$$

For example, the value of N_{DBPS,short,u} may be defined in accordance with an IEEE 802.11 Specification, for example, in case Na=2.

For example, the value of Na may represent the number of bits to indicate the “a” factor.

For example, if using the value Na #2, then the value of N_{DBPS,short,u} may be redefined based on the value of Na. For example, the value of N_{DBPS,short,u} for Na=3 may be determined, for example, by dividing by two the value of value of N_{DBPS,short,u} for Na=2.

In some demonstrative aspects, it may be defined according to the UHR MU PPDU padding process that the transmitter is to derive, among all the users, the set of the user indices S, with the longest encoded packet duration, e.g., as follows:

$$S = arg {max}_{u = 0 , 1 , … , {N}_{user , total} - 1} ( {N}_{SYM , init , u} - 1 + \frac{{a}_{init , u}}{{2}^{{N}_{a}}} )$$

wherein:

$$arg max f ( x ) := \{ x ∈ [ 0 , {N}_{user , total} - 1 ] : f ( y ) \leq f ( x ) for all \\ y ∈ [ 0 , {N}_{user , total} - 1 ] \}$$

In some demonstrative aspects, it may be defined according to the UHR MU PPDU padding process that the common a_{init,u} and N_{SYM,init,u} values among all the users are to be derived, e.g., as follows:

aᵢₙᵢₜ=aᵢₙᵢₜ,max

N_{SYM,init}=N_{SYM,init},max

In some demonstrative aspects, it may be defined according to the UHR MU PPDU padding process that the transmitter is to then calculate each user's initial number of data bits and initial number of coded bits in its last OFDM symbol, e.g., as follows:

$${N}_{DPBS , last , init , u} = \{ \begin{matrix}{a}_{init} \cdot {N}_{DBPS , short , u} & if {a}_{init} < {2}^{{N}_{a}} \\ {N}_{DBPS , u} & if {a}_{init} = {2}^{{N}_{a}}\end{matrix}$$

$${N}_{CBPS , last , init , u} = \{ \begin{matrix}{b}_{init} \cdot {N}_{CBPS , short , u} & if {b}_{init} < {2}^{{N}_{b}} \\ {N}_{CBPS , u} & if {b}_{init} = {2}^{{N}_{b}}\end{matrix}$$

wherein Ng is the number of bits to indicate the post-FEC padding (PHY) boundary in the last OFDM symbol. For example, it may be defined that N_{b}≤Nₐ, wherein:

$${b}_{init} = ⌈ \frac{{a}_{init}}{{2}^{{N}_{a}} / {2}^{{N}_{b}}} ⌉ \\ {N}_{CBPS , short , u} = {2}^{{N}_{a}} / {2}^{{N}_{b}} \cdot \frac{{N}_{DBPS , short , u}}{R}$$

In some demonstrative aspects, it may be defined according to the UHR MU PPDU padding process that for each user with LDPC encoding, the parameters N_{pid,u} and N_{avbits,u} are to be computed, e.g., as follows:

$${N}_{pld , u} = ( {N}_{SYM , init} - 1 ) {N}_{DBPS , u} + {N}_{DBPS , last , init , u}$$

$${N}_{avbits , init , u} = ( {N}_{SYM , init} - 1 ) {N}_{CBPS , u} + {N}_{CBPS , last , init , u}$$

In some demonstrative aspects, it may be defined according to the UHR MU PPDU padding process that an LDPC PPDU encoding process is to be implemented to calculate the number of shortening/puncturing/repetition bits over all the N_{CW,u} codewords, e.g., in accordance with an IEEE 802.11 Specification.

In some demonstrative aspects, it may be defined according to the UHR MU PPDU padding process that an LDPC extra segment, or an LDPC extra symbol, is to be added, if needed. This may apply to all the users, and all users with LDPC encoding shall increment the number of capability bits, N_{avbits,u}, e.g., as follows:

$${N}_{avbits , u} = \{ \begin{matrix}{N}_{avbits , init , u} + {N}_{CBPS , u} − ( {2}^{{N}_{b}} − 1 ) \cdot {N}_{CBPS , short , u} & if {b}_{i n i t} = {2}^{{N}_{b}} - 1 \\ {N}_{avbits , init , u} + {N}_{CBPS , short , u} & otherwise\end{matrix}$$

In some demonstrative aspects, it may be defined according to the UHR MU PPDU padding process that the common PHY boundary factor b and N_{SYM} values for all users are to be updated, e.g., as follows:

$$\begin{matrix}{N}_{SYM , init} + 1 and b = 1 & if {b}_{init} = {2}^{{N}_{b}} \\ {N}_{SYM , init} and b = {b}_{init} + 1 & otherwise\end{matrix}$$

For example, it may be defined according to the UHR MU PPDU padding process that the LDPC extra segment is to be added, for example, with a unit of 1/2^{Nb} OFDM symbol.

In some demonstrative aspects, it may be defined according to the UHR MU PPDU padding process that, for each user, the number of post-FEC padding bits in the last symbol is to be computed, e.g., as follows:

N_{PAD,Post-FEC,u}=N_{CBPS,u}−N_{CBPS,last,u}

In some demonstrative aspects, it may be defined according to the UHR MU PPDU padding process that, among the pre-FEC padding bits, the MAC is to deliver a PSDU that fills the available octets in the data field of the UHR PPDU, toward the desired initial pre-FEC padding boundary represented by aᵢₙᵢₜ for users encoded by LDPC; and that the PHY is then to determine the number of padding bits to add and append them to the PSDU, e.g., as follows:

$${N}_{PAD , Pre - FEC , MAC , u} = 8 \cdot ⌊ \frac{{N}_{pld , Pre - FEC , u}}{8} ⌋$$

$${N}_{PAD , P r e - FEC , PHY , u} = {N}_{pld , Pre - FEC , u} mod 8$$

wherein:

$${N}_{pld , Pre - FEC , u} =$$

$$= ( {N}_{SYM , init} - 1 ) {N}_{DBPS , u} + {N}_{DBPS , last , init , u} - 8 \cdot {APEP}_{{LENGTH}_{u}} - {N}_{service}$$

In some demonstrative aspects, it may be defined according to the UHR MU PPDU padding process that Na bits are to be used to indicate the pre-FEC “a” factor, e.g., representing the pre-FEC padding boundary.

In some demonstrative aspects, it may be defined according to the UHR MU PPDU padding process that a subset of the Nₐ bits, e.g., the first N_{b} bits or the last N_{b} bits, within the Nₐ bits are to be used to indicate the post-FEC padding (PHY) boundary, e.g., as described below.

For example, the pre-FEC padding (MAC) boundary and the post-FEC padding (PHY) boundary may be indicated by the same set of the Nₐ bits in the SIG

### FIELD

In some demonstrative aspects, it may be defined according to the UHR MU PPDU padding process is to be configured according to the value N_{b}=0, and the value Nₐ=2. For example, this setting may support a PHY boundary granularity of 1 OFDM symbol.

For example, the Pre-FEC padding (MAC) boundary may be indicated by three bits, including two bits representing the “a” factor, e.g., denoted as bits (A0,A1), together with a 1-bit LDPC extra symbol segment, e.g., denoted as a bit (B0), and the number of OFDM symbols. For example, the bits (A0,A1) may include the bits B10-B11 in a common field in the SIG field of the PPDU. For example, the bit (B0) may include the bit B9 in the common field in the SIG field of the PPDU.

For example, the post-FEC padding (PHY) boundary may be indicated by the number of OFDM symbols only, e.g., such that there will be no post-FEC padding.

For example, the Pre-FEC padding (MAC) boundary and the post-FEC padding (PHY) boundary may be indicated using the three bits (A0,A1) and B0, e.g., as follows:

TABLE 1

| (A0, A1) | B0 | | |
|---|---|---|---|
| (e.g., B10-B11) | (e.g., B9) | MAC boundary | PHY boundary |
| 00 | 0 | N_sym-1 + 1/4 | N_sym |
| 01 | 0 | N_sym-1 + 2/4 | N_sym |
| 00 | 1 | N_sym-2 + 1/4 | N_sym |
| 01 | 1 | N_sym-2 + 2/4 | N_sym |
| 10 | 0 | N_sym-1 + 3/4 | N_sym |
| 11 | 0 | N_sym-1 + 4/4 | N_sym |
| 10 | 1 | N_sym-2 + 3/4 | N_sym |
| 11 | 1 | N_sym-2 + 3/4 | N_sym |

In some demonstrative aspects, it may be defined according to the UHR MU PPDU padding process is to be configured according to the value N_{b}=1, and the value Nₐ=2. For example, this setting may support a post-FEC padding granularity of 1/2 OFDM symbol.

For example, the Pre-FEC padding (MAC) boundary may be indicated by three bits, including two bits representing the “a” factor, e.g., denoted as bits (A0,A1), together with a 1-bit LDPC extra symbol segment, e.g., denoted as a bit (B0), and the number of OFDM symbols. For example, the bits (A0,A1) may include the bits B10-B11 in a common field in the SIG field of the PPDU. For example, the bit (B0) may include the bit B9 in the common field in the SIG field of the PPDU.

For example, the post-FEC padding (PHY) boundary factor “b” may be indicated by the value of a bit of the bits (A0,A1), e.g., the bit A0 or the bit A1, together with the number of OFDM symbols.

For example, the Pre-FEC padding (MAC) boundary and the post-FEC padding (PHY) boundary may be indicated using the three bits (A0,A1) and B0, e.g., as follows:

TABLE 2

| (A0, A1) | B0 | | |
|---|---|---|---|
| (e.g., B10-B11) | (e.g., B9) | MAC boundary | PHY boundary |
| 00 | 0 | N_sym-1 + 1/4 | N_sym-1/2 |
| 01 | 0 | N_sym-1 + 2/4 | N_sym-1/2 |
| 00 | 1 | N_sym-1-1/4 | N_sym-1/2 |
| 01 | 1 | N_sym-1 | N_sym-1/2 |
| 10 | 0 | N_sym-1 + 3/4 | N_sym |
| 10 | 0 | N_sym-1 + 4/4 | N_sym |
| 11 | 1 | N_sym-1 + 1/4 | N_sym |
| 11 | 1 | N_sym-1 + 2/4 | N_sym |

For example, the values in Table 2 are defined based on the definition that the PHY boundary is to be indicated by the bit A0 with the number of OFDM symbols. For example, as shown in Table 2, when A0=0, the last 1/2 OFDM symbol will be filled with post-FEC padding.

For example, in case the number of bits to indicate the “a” factor is kept to include two bits, then no additional bits may be required in the SIG field, e.g., a Universal SIG (U-SIG) field, to indicate the pre-FEC padding and the post-FEC padding boundary.

For example, for the post-FEC padding boundary, the number of indication bits, Ng, which may be selected from the Nₐ bits of the “a” factor, may be defined with a fixed value. For example, this predefined value may be decided per user/application based with pre-negotiation between the AP and the STA, per PPDU type, and/or based on any other additional or alternative metrics, parameters and/or criteria.

In one example, the value of N_{b} may be defined to be equal to Nₐ, for example, to provide a technical solution to support a reduced PE definition.

In another example, the value of Ng may be defined to be N_{b}=0, for example, to provide a technical solution to improve Packet Error Rate (PER) performance. For example, this setting of the value of Ng may remove the post-FEC padding.

In some demonstrative aspects, a duration, denoted TPE, of a PE field, may be defined, for example, based on the pre-FEC adding factor “a”.

For example, a mapping between the pre-FEC adding factor “a” and nominal TPE values may be defined, for example, if it is defined that N_{b}+Nₐ.

For example, the post-FEC padding boundary may be determined by the N_{b} bits “b” factor. Accordingly, the nominal TPE value may be determined by the “b” factor with the TXVECTOR parameter NOMINAL_PACKET_PADDING, e.g., for an HE SU PPDU or HE ER SU PPDU, or with the TXVECTOR parameter NOMINAL_PACKET_PADDING [u], e.g., for an HE MU PPDU.

For example, in case of defining N_{b}=0, the Nominal TPE value may be independent of the “b” factor. For example, in this case, the Nominal TPE value may be a fixed value, which may be determined directly, for example, by only the TXVECTOR parameter NOMINAL_PACKET_PADDING, e.g., for an HE SU PPDU or HE ER SU PPDU, or with the TXVECTOR parameter NOMINAL_PACKET_PADDING [u], e.g., for an HE MU PPDU.

For example, in case of defining N_{b}=1, the granularity of the post-FEC padding may be 1/2 OFDM symbol, and a mapping table for a mapping between the post-FEC adding factor “b” and the nominal TPE values may be defined, e.g., as follows:

TABLE 3

| | TXVECTOR parameter NOMINAL_PACKET_PADDING | | |
|---|---|---|---|
| | (HE SU PPDU or HE ER SU PPDU) or | | |
| | NOMINAL_PACKET_PADDING[u] (HE MU PPDU) | | |
| b | 0 μs | 8 μs | 16 μs |
| 1 | 0 μs | 0 μs | 8 μs |
| 2 | 0 μs | 8 μs | 16 μs |

Table 3

In some demonstrative aspects, device 102, device 140, and/or device 160 may be configured to implement one or more operations and/or functionalities of a UHR encoding process (also referred to below as a “UHR/UHR+encoding process”), which may be applied to a UHR/UHR+SU PPDU transmission and/or to a UHR/UHR+MU PPDU transmission to multiple users, e.g., as described below.

For example, it may be defined that for an UHR/UHR+MU PPDU, all the users shall use a common value of a pre-FEC padding factor “a” and a common value of N_{SYM}.

For example, the UHR/UHR+encoding process may utilize a UHR/UHR+PPDU padding process, e.g., as described below.

In some demonstrative aspects, the UHR/UHR+PPDU padding process may be configured according to a pre-FEC padding factor a=4, and according to the third FEC padding technique, which may be configured based on a condition that no post-FEC padding is to be applied for an encoded UHR MU PPDU, e.g., as described below.

In some demonstrative aspects, it may be defined according to the UHR/UHR+PPDU coding process that in a UHR MU PPDU transmission, the transmitter first computes the number of data bits left in the last OFDM symbol for user u, e.g., as follows:

$${N}_{Excess , u} = ( 8 \cdot {APEP\_LENGTH}_{u} + {N}_{t a i l , u} + {N}_{service} ) mod {N}_{DBPS , u}$$

wherein:
APEP_LENGTHᵤ is the TXVECTOR parameter APEP_LENGTH for the u-th user,
N_{tail,u} is the number of tails bits per encoder for user u,
N_{service} is the number of bits in the SERVICE field, and
N_{DBPS,u} is the number of data bits per OFDM symbol for the u-th user.

In some demonstrative aspects, it may be defined according to the UHR/UHR+PPDU coding process that, for example, based on N_{Excess},u, the transmitter then computes the initial number of symbol segments in the last OFDM symbol, (“the initial pre-FEC factor value a_{init,u}”), and the initial number of OFDM symbols, N_{SYM,init,u}, for the user u, e.g., as follows:

$${a}_{i n i t , u} = \{ \begin{matrix}4 , & if {N}_{Excess , u} \\ min ( [ \frac{{N}_{Excess , u}}{{N}_{DBPS , short , u}} ] , 4 ) , & otherwise\end{matrix}$$

$${N}_{SYM , i n i t , u} = ⌈ \frac{{APEP\_LENGTH}_{u} \times 8 + {N}_{t a i ι , u} + {N}_{s e r ν i c e}}{{N}_{DBPS , u}} ⌉$$

wherein:
N_{DBPS,short,u}=N_{CBPS,short,u}·Rᵤ
   wherein:
Rᵤ denotes a coding rate for the u-th user,
N_{CBPS,short,u}=N_{SD,short,u}·N_{ss,u}·N_{BPSCS,u},
   wherein N_{SD,short,u} is a value of N_{SD,short} corresponding to the occupied Resource Unit (RU) or Multiple RU (MRU) size of the u-th user, wherein N_{ss,u} denotes a number of spatial streams for the u-th user, and wherein N_{BPSCS,u} denotes a number of coded bits per subcarrier per spatial stream for the u-th user.

In some demonstrative aspects, it may be defined according to the UHR/UHR+PPDU coding process that the transmitter is to derive, among all the users, the set of the user indices S, with the longest encoded packet duration, and select one value from the set as Uₘₐₓ, e.g., as follows:

$$S = arg {max}_{u = 0 , 1 , … , {N}_{u s e r , t o t a l} - 1} ( {N}_{SYM , i n i t , u} - 1 + \frac{{a}_{i n i t , u}}{4} )$$

wherein:

$$arg max f ( x ) := \{ x ∈ [ 0 , {N}_{u s e r , t o t a l} - 1 ] : f ( y ) \leq f ( x ) for all y ∈ [ 0 , {N}_{u s e r , t o t a l} - 1 ] \}$$

In some demonstrative aspects, it may be defined according to the UHR/UHR+PPDU coding process that the common a and N_{SYM,init} values among all the users are to be derived, e.g., as follows:

a=a_{init,U}_{ₘₐₓ}

N_{SYM,init}=N_{SYM,init,U}_{ₘₐₓ}

In some demonstrative aspects, it may be defined according to the UHR/UHR+PPDU coding process that the transmitter is to then calculate each user's initial number of data bits and initial number of coded bits in its last OFDM symbol, e.g., as follows:

$${N}_{DBPS , l a s t , u} = \{ \begin{matrix}a \cdot {N}_{DBPS , short , u} & if a < 4 \\ {N}_{DBPS , u} & if a = 4\end{matrix}$$

In some demonstrative aspects, it may be defined according to the UHR/UHR+PPDU coding process that for each user with LDPC encoding, the parameters N_{pld,u} and N_{avbits,u} are to be computed, e.g., as follows:

$${N}_{pld , u} = ( {N}_{SYM , init} - 1 ) {N}_{DBPS , u} + {N}_{DBPS , last , u}$$

$${N}_{avbits , u} = {N}_{SYM , init} {N}_{CBPS , u}$$

In some demonstrative aspects, it may be defined according to the UHR/UHR+PPDU coding process that an LDPC PPDU encoding process is to be implemented, e.g., in accordance with an IEEE 802.11 Specification, for example, starting with the parameters N_{pld,u} and N_{avbits,u} calculated per the above equations.

In some demonstrative aspects, it may be defined according to the UHR/UHR+PPDU coding process that, for example, if there is at least one user with LDPC encoding for which a predefined condition, e.g., the following condition (“Condition 1”), is met:

$$( {N}_{p u n c , u} > 0.1 \times {N}_{C W , u} \times {L}_{L D P C , u} \times ( 1 - {R}_{u} ) ) AND \qquad Condition ( 1 )$$

$$( {N}_{S h r t , u} < 1.2 \times {N}_{p u n c , u} \times \frac{{R}_{u}}{1 - {R}_{u}} ) is true$$

$$OR$$

$${N}_{p u n c , u} > 0.3 \times {N}_{C W , u} \times {L}_{L D P C , u} \times ( 1 - {R}_{u} ) is true$$

wherein N_{punc,u}, N_{cw.u}, L_{LDPC,u}, and N_{shrt,u} are the LDPC encoding parameters for the user u, and Ry is the coding rate for the user u, then the LDPC extra OFDM symbol field in the SIG field, e.g., the UHR-SIG, of the PPDU shall be set to 1, and all users with LDPC encoding shall increment N_{avbits} and recompute N_{punc}, e.g., as follows:

$${N}_{a ν b i t s , u} = {N}_{a ν b i t s , u} + {N}_{C B P S , u}$$

$${N}_{p u n c , u} = max ( 0 , {N}_{C W , u} \times {L}_{L D P C , u} - {N}_{a ν b i t s , u} - {N}_{s h r t , u} )$$

and then the N_{SYM} values for all users shall be updated, e.g., as follows:

$${N}_{S Y M} = {N}_{SYM , init} + 1$$

In some demonstrative aspects, it may be defined according to the UHR/UHR+PPDU coding process that, for example, if the Condition (1) is not met by any of the users with LDPC encoding, or if all the users scheduled in the UHR MU PPDU are BCC encoded, then the LDPC extra OFDM symbol field of the SIG field, e.g., the UHR-SIG, shall be set to 0, and the N_{SYM} values for all users shall be updated, e.g., as follows:

N_{SYM}=N_{SYM,init}

In some demonstrative aspects, it may be defined according to the UHR/UHR+PPDU coding process that, for example, for each user with LDPC encoding, the number of pre-FEC padding bits for the u-th user may be computed, e.g., as follows:

$${N}_{pld , Pre - F E C , u} == ( {N}_{S Y M , i n i t} - 1 ) {N}_{D B P S , u} + {N}_{D BPS , last , u} - 8 \cdot APE {P}_{L E N G T {H}_{u}} - {N}_{service}$$

In some demonstrative aspects, it may be defined according to the UHR/UHR+PPDU coding process that, for example, for a user with BCC encoding, the number of pre-FEC padding bits may be determined, e.g., as follows:

$${N}_{pld , Pre - F E C , u} == ( {N}_{S Y M} - 1 ) {N}_{D B P S , u} + {N}_{D BPS , last , u} - 8 \cdot APE {P}_{L E N G T {H}_{u}} - {N}_{service}$$

In some demonstrative aspects, it may be defined according to the UHR/UHR+PPDU coding process that there will be no post FEC padding for each user with either LDPC or BCC encoding.

In some demonstrative aspects, it may be defined according to the UHR/UHR+PPDU coding process that, for example, among the pre-FEC padding bits, the MAC may deliver a PSDU that fills the available octets in the data field of the UHR PPDU, for example, toward the desired initial pre-FEC padding boundary represented by aᵢₙᵢₜ for users encoded by LDPC; and that the PHY may then determine the number of padding bits to add, and may append them to the PSDU, e.g., as follows:

$${N}_{P A D , P r e - F E C , M A C , u} = 8 \cdot ⌊ \frac{{N}_{pld , Pre - F E C , u}}{8} ⌋$$

$${N}_{P A D , P r e - F E C , P H Y , u} = {N}_{pld , Pre - F E C , u}$$

In some demonstrative aspects, it may be defined according to the UHR/UHR+PPDU coding process that, for example, a bit in a SIG field, for example, in the UHR-SIG field, e.g., the bit B9 field in a common field in a SIG field for an OFDMA transmission, and/or the bit B9 field in a common field in a SIG field for a non-OFDMA transmission, may be defined to refer to an LDPC extra OFDM symbol, e.g., as follows:

TABLE 4

| | | | Number | |
|---|---|---|---|---|
| | | Number | of bits | |
| | | of | per | |
| Bit | Subfield | subfields | subfield | Description |
| B9 | LDPC | 1 | 1 | Indicates the presence of the |
| | Extra | | | LDPC extra OFDM symbol: |
| | OFDM | | | Set to 1 if an LDPC extra |
| | Symbol | | | OFDM symbol is present. |
| | | | | Set to 0 if an LDPC extra |
| | | | | OFDM symbol is not present. |

In some demonstrative aspects, it may be defined according to the UHR/UHR+PPDU coding process that, for example, a bit in a common info field in a trigger frame may be defined to refer to an LDPC extra OFDM symbol. For example, it may be defined that a bit B27 in the common info field in the trigger frame may represent an LDPC Extra OFDM Symbol subfield. For example, it may be defined that the LDPC Extra OFDM Symbol subfield of the Common Info field indicates the status of the LDPC extra OFDM symbol. For example, it may be defined that the LDPC Extra OFDM Symbol subfield is set to 1 if the LDPC extra OFDM symbol is present in the solicited HE TB PPDUs, and set to 0 otherwise.

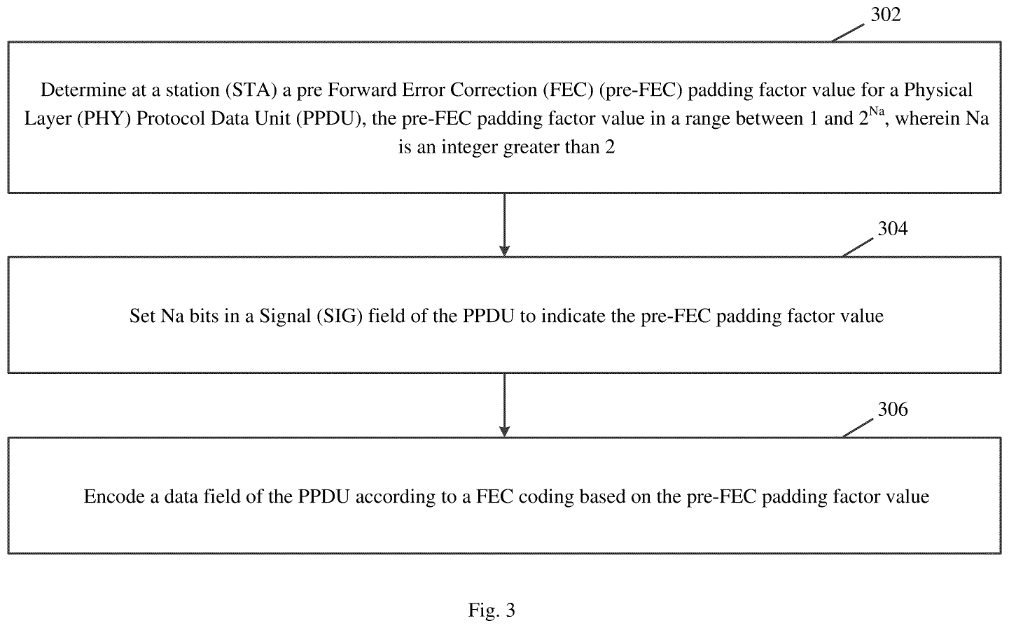

Reference is made to FIG. 3, which schematically illustrates a method of FEC coding, in accordance with some demonstrative aspects. For example, one or more of the operations of the method of FIG. 3 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 302, the method may include determining at a STA a pre-FEC padding factor value for a PPDU, the pre-FEC padding factor value in a range between 1 and 2Nₐ, wherein Nₐ is an integer greater than 2. For example, controller 124 (FIG. 1) may be configured to cause, trigger, and/or control the STA implemented by device 102 (FIG. 1) to determine the pre-FEC padding factor value for the PPDU, e.g., as described above.

As indicated at block 304, the method may include setting Nₐ bits in a Signal (SIG) field of the PPDU to indicate the pre-FEC padding factor value. For example, controller 124 (FIG. 1) may be configured to cause, trigger, and/or control the STA implemented by device 102 (FIG. 1) to set the Nₐ bits in the SIG field of the PPDU to indicate the pre-FEC padding factor value, e.g., as described above.

As indicated at block 306, the method may include encoding a data field of the PPDU according to a FEC coding based on the pre-FEC padding factor value. For example, controller 124 (FIG. 1) may be configured to cause, trigger, and/or control the STA implemented by device 102 (FIG. 1) to encode the data field of the PPDU according to the FEC coding based on the pre-FEC padding factor value, e.g., as described above.

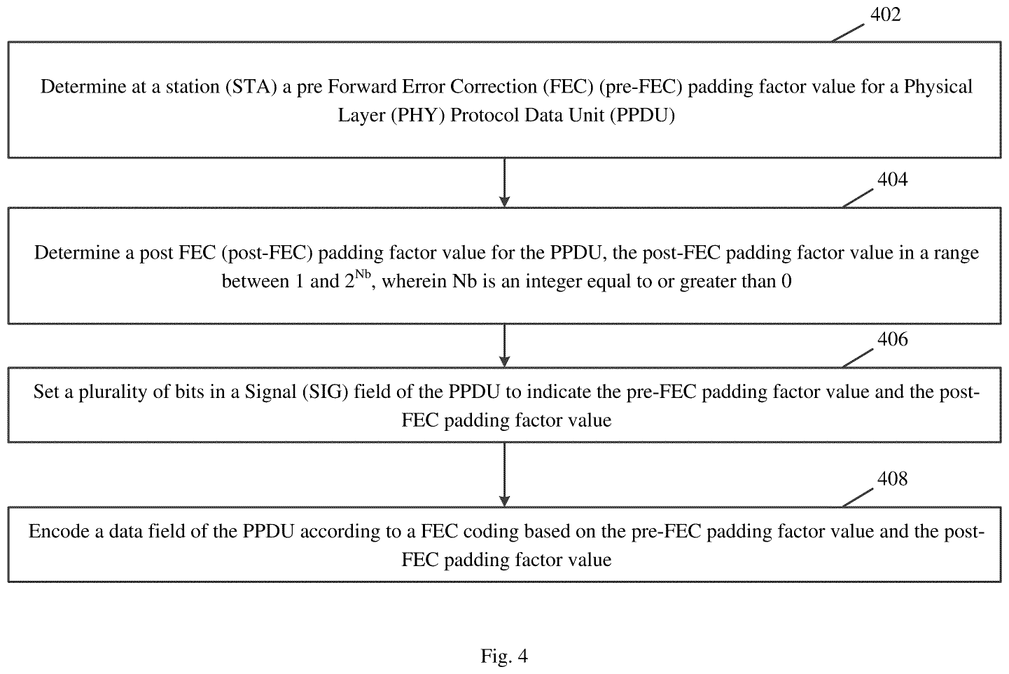

Reference is made to FIG. 4, which schematically illustrates a method of FEC coding, in accordance with some demonstrative aspects. For example, one or more of the operations of the method of FIG. 4 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 402, the method may include determining at a STA a pre-FEC padding factor value for a PPDU. For example, controller 124 (FIG. 1) may be configured to cause, trigger, and/or control the STA implemented by device 102 (FIG. 1) to determine the pre-FEC padding factor value for the PPDU, e.g., as described above.

As indicated at block 404, the method may include determining a post-FEC padding factor value for the PPDU, the post-FEC padding factor value in a range between 1 and 2ND, wherein N_{b} is an integer equal to or greater than 0. For example, controller 124 (FIG. 1) may be configured to cause, trigger, and/or control the STA implemented by device 102 (FIG. 1) to determine the post-FEC padding factor value for the PPDU, e.g., as described above.

As indicated at block 406, the method may include setting a plurality of bits in a Signal (SIG) field of the PPDU to indicate the pre-FEC padding factor value and the post-FEC padding factor value. For example, controller 124 (FIG. 1) may be configured to cause, trigger, and/or control the STA implemented by device 102 (FIG. 1) to set the plurality of bits in the SIG field of the PPDU to indicate the pre-FEC padding factor value and the post-FEC padding factor value, e.g., as described above.

As indicated at block 408, the method may include encoding a data field of the PPDU according to a FEC coding based on the pre-FEC padding factor value and the post-FEC padding factor value. For example, controller 124 (FIG. 1) may be configured to cause, trigger, and/or control the STA implemented by device 102 (FIG. 1) to encode the data field of the PPDU according to the FEC coding based on the pre-FEC padding factor value and the post-FEC padding factor value, e.g., as described above.

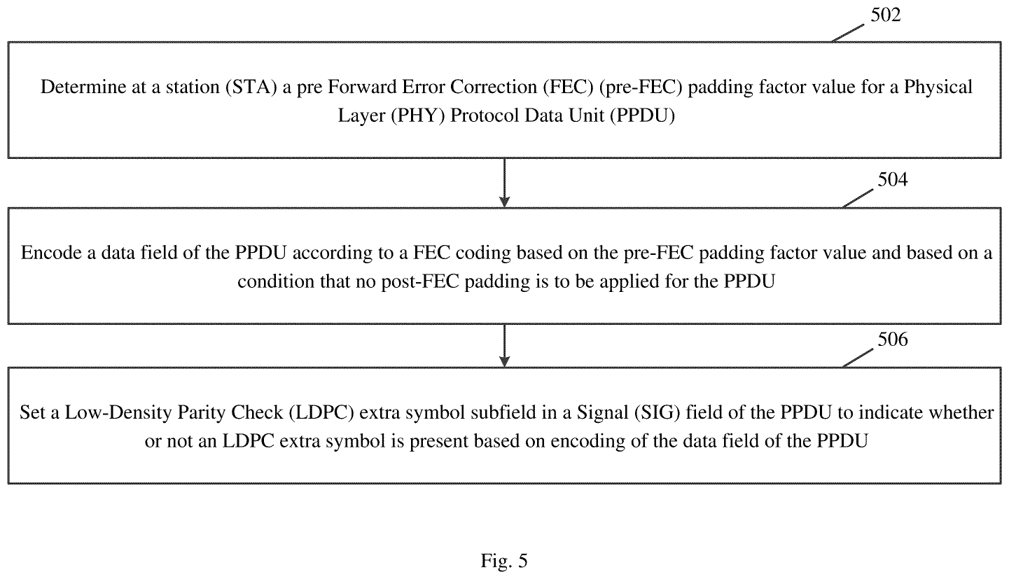

Reference is made to FIG. 5, which schematically illustrates a method of FEC coding, in accordance with some demonstrative aspects. For example, one or more of the operations of the method of FIG. 5 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 502, the method may include determining at a STA a pre-FEC padding factor value for a PPDU. For example, controller 124 (FIG. 1) may be configured to cause, trigger, and/or control the STA implemented by device 102 (FIG. 1) to determine the pre-FEC padding factor value for the PPDU, e.g., as described above.

As indicated at block 504, the method may include encoding a data field of the PPDU according to a FEC coding based on the pre-FEC padding factor value and based on a condition that no post-FEC padding is to be applied for the PPDU. For example, controller 124 (FIG. 1) may be configured to cause, trigger, and/or control the STA implemented by device 102 (FIG. 1) to encode the data field of the PPDU according to the FEC coding based on the pre-FEC padding factor value and based on the condition that no post-FEC padding is to be applied for the PPDU, e.g., as described above.

As indicated at block 506, the method may include setting an LDPC extra symbol subfield in a SIG field of the PPDU to indicate whether or not an LDPC extra symbol is present based on encoding of the data field of the PPDU. For example, controller 124 (FIG. 1) may be configured to cause, trigger, and/or control the STA implemented by device 102 (FIG. 1) to set the LDPC extra symbol subfield in the SIG field of the PPDU to indicate whether or not the LDPC extra symbol is present based on encoding of the data field of the PPDU, e.g., as described above.

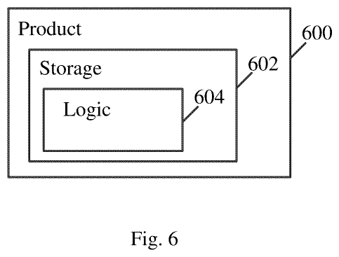

Reference is made to FIG. 6, which schematically illustrates a product of manufacture 600, in accordance with some demonstrative aspects. Product 600 may include one or more tangible computer-readable (“machine-readable”) non-transitory storage media 602, which may include computer-executable instructions, e.g., implemented by logic 604, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIGS. 1-5, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 600 and/or machine readable storage media 602 may include one or more types of computer-readable storage media capable of storing data, including volatile memory, non-volatile memory, removable or non-removable memory, erasable or non-erasable memory, writeable or re-writeable memory, and the like. For example, machine readable storage media 602 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 604 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 604 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising logic and circuitry configured to cause a wireless communication station (STA) to determine a pre Forward Error Correction (FEC) (pre-FEC) padding factor value for a Physical Layer (PHY) Protocol Data Unit (PPDU), the pre-FEC padding factor value in a range between 1 and 2Nₐ, wherein Nₐ is an integer greater than 2; set Nₐ bits in a Signal (SIG) field of the PPDU to indicate the pre-FEC padding factor value; and encode a data field of the PPDU according to a FEC coding based on the pre-FEC padding factor value.

Example 2 includes the subject matter of Example 1, and optionally, wherein the apparatus is configured to cause the STA to determine a number of pre-FEC padding bits based on the pre-FEC padding factor value, and to encode the data field of the PPDU according to the FEC coding using the number of pre-FEC padding bits.

Example 3 includes the subject matter of Example 1 or 2, and optionally, wherein the apparatus is configured to cause the STA to determine a number of data bits for a last Orthogonal Frequency Division Multiplexing (OFDM) symbol of the PPDU based on the pre-FEC padding factor value, and to encode the data field of the PPDU based on the number of data bits for the last OFDM symbol of the PPDU.

Example 4 includes the subject matter of Example 3, and optionally, wherein the apparatus is configured to cause the STA to determine a total number of bits in a PHY Service Data Unit (PSDU) and service field based on the number of data bits for the last OFDM symbol of the PPDU, and to encode the data field of the PPDU based on the total number of bits in the PSDU and the service field.

Example 5 includes the subject matter of Example 3 or 4, and optionally, wherein the apparatus is configured to cause the STA to determine the pre-FEC padding factor value comprising an initial pre-FEC padding factor value, and to determine the number of data bits for the last OFDM symbol of the PPDU comprising a number of data bits for the last OFDM symbol for a u-th user as follows:

$${N}_{D B P S , l a s t , i n i t , u} = \{ \begin{matrix}{a}_{init} \cdot {N}_{DBPS , short , u} & if {a}_{init} < {2}^{{N}_{a}} \\ {N}_{DBPS , u} & if {a}_{init} = {2}^{{N}_{a}}\end{matrix}$$

wherein N_{DBPS,last,init,u} denotes the number of data bits for the last OFDM symbol for the u-th user, wherein aᵢₙᵢₜ denotes the initial pre-FEC padding factor value, wherein N_{DBPS,u} denotes a number of data bits per OFDM symbol for the u-th user, wherein N_{DBPS,short,u} denotes a short number of data bits per OFDM symbol for the u-th user.

Example 6 includes the subject matter of any one of Examples 1-5, and optionally, wherein the apparatus is configured to cause the STA to determine the pre-FEC padding factor value comprising an initial pre-FEC padding factor value for a u-th user as follows:

$${a}_{i n i t , u} = \{ \begin{matrix}{2}^{{N}_{a}} , & if {N}_{Excess , u} = 0 \\ min ( [ \frac{{N}_{Excess , u}}{{N}_{DBPS , short , u}} ] , {2}^{{N}_{a}} ) , & otherwise\end{matrix}$$

wherein a_{init,u} denotes the initial pre-FEC padding factor value for the u-th user, wherein N_{Excess,u} denotes a number of data bits left in a last Orthogonal Frequency Division Multiplexing (OFDM) symbol for the u-th user, wherein N_{DBPS,short,u} denotes a short number of data bits per OFDM symbol for the u-th user.

Example 7 includes the subject matter of any one of Examples 1-6, and optionally, wherein the apparatus is configured to cause the STA to determine the pre-FEC padding factor value based on a number of data bits left in a last Orthogonal Frequency Division Multiplexing (OFDM) symbol of the PPDU.

Example 8 includes the subject matter of any one of Examples 1-7, and optionally, wherein the apparatus is configured to cause the STA to configure a Medium Access Control (MAC) pre-FEC padding boundary for the PPDU based on the pre-FEC padding factor value, and to encode the data field of the PPDU according to the FEC coding based on the MAC pre-FEC padding boundary, wherein the MAC pre-FEC padding boundary comprises a number of symbol segments, in the range between 1 and 2Nₐ, for MAC pre-FEC padding in a last Orthogonal Frequency Division Multiplexing (OFDM) symbol of the PPDU.

Example 9 includes the subject matter of any one of Examples 1-8, and optionally, wherein the apparatus is configured to cause the STA to set an other bit in the SIG field such that a combination of the Nₐ bits and the other bit is to indicate a Medium Access Control (MAC) pre-FEC padding boundary for the PPDU.

Example 10 includes the subject matter of Example 9, and optionally, wherein the other bit comprises a bit representing a Low-Density Parity Check (LDPC) extra symbol segment subfield or an LDPC extra symbol subfield.

Example 11 includes the subject matter of any one of Examples 1-10, and optionally, wherein Nₐ=3.

Example 12 includes the subject matter of Example 11, and optionally, wherein the Nₐ bits comprises bits B10-B11 of the SIG field, and a bit of bits B13-B17 of the SIG field.

Example 13 includes the subject matter of any one of Examples 1-12, and optionally, wherein the apparatus is configured to cause the STA to configure the FEC coding based on the pre-FEC padding factor value such that no post-FEC padding is to be applied for the PPDU.

Example 14 includes the subject matter of any one of Examples 1-13, and optionally, wherein the apparatus is configured to cause the STA to determine a post FEC (post-FEC) padding factor value for the PPDU, the post-FEC padding factor value in a range between 1 and 2^{Nb}, wherein Nb is equal to or greater than 0; and encode the data field of the PPDU according to the FEC coding based on the post-FEC padding factor value.

Example 15 includes the subject matter of Example 14, and optionally, wherein the apparatus is configured to cause the STA to determine the post-FEC padding factor value based on the pre-FEC padding factor value and a ratio between 2^{Na} and 2^{Nb} (2^{Na}/2^{Nb}).

Example 16 includes the subject matter of Example 14 or 15, and optionally, wherein the apparatus is configured to cause the STA to determine a number of coded bits for a last Orthogonal Frequency Division Multiplexing (OFDM) symbol of the PPDU based on the post-FEC padding factor value, and to encode the data field of the PPDU based on the number of coded bits for the last OFDM symbol of the PPDU.

Example 17 includes the subject matter of Example 16, and optionally, wherein the apparatus is configured to cause the STA to determine a number of available bits for the data field based on the number of coded bits for the last OFDM symbol of the PPDU, and to encode the data field of the PPDU based on the number of available bits for the data field.

Example 18 includes the subject matter of any one of Examples 14-17, and optionally, wherein the apparatus is configured to cause the STA to set the Na bits to indicate both the pre-FEC padding factor value and the post-FEC padding factor value.

Example 19 includes the subject matter of any one of Examples 14-18, and optionally, wherein Nb=0.

Example 20 includes the subject matter of any one of Examples 14-18, and optionally, wherein Nb=1.

Example 21 includes the subject matter of any one of Examples 14-18, and optionally, wherein Nb=Na.

Example 22 includes the subject matter of any one of Examples 14-18, and optionally, wherein Nb is different from Na.

Example 23 includes the subject matter of any one of Examples 1-22, and optionally, wherein the FEC coding comprises a Low-Density Parity Check (LDPC) coding.

Example 24 includes the subject matter of any one of Examples 1-23, and optionally, wherein the PPDU comprises a Multi-User (MU) PPDU for a plurality of users, wherein the pre-FEC padding factor value comprises a common pre-FEC padding factor value to be applied for all users.

Example 25 includes the subject matter of any one of Examples 1-23, and optionally, wherein the PPDU comprises a Single-User (SU) PPDU for a single user.

Example 26 includes the subject matter of any one of Examples 1-25, and optionally, comprising a radio to transmit the PPDU.

Example 27 includes the subject matter of Example 26, and optionally, comprising one or more antennas connected to the radio, and a processor to execute instructions of an operating system.

Example 28 includes an apparatus comprising logic and circuitry configured to cause a wireless communication station (STA) to determine a pre Forward Error Correction (FEC) (pre-FEC) padding factor value for a Physical Layer (PHY) Protocol Data Unit (PPDU); determine a post FEC (post-FEC) padding factor value for the PPDU, the post-FEC padding factor value in a range between 1 and 2Nb, wherein Nb is an integer equal to or greater than 0; set a plurality of bits in a Signal (SIG) field of the PPDU to indicate the pre-FEC padding factor value and the post-FEC padding factor value; and encode a data field of the PPDU according to a FEC coding based on the pre-FEC padding factor value and the post-FEC padding factor value.

Example 29 includes the subject matter of Example 28, and optionally, wherein the apparatus is configured to cause the STA to set the plurality of bits such that a combination of the plurality of bits is to indicate the pre-FEC padding factor value, and such that one or more predefined bits of the plurality of bits is to indicate the post-FEC padding factor value.

Example 30 includes the subject matter of Example 28 or 29, and optionally, wherein the apparatus is configured to cause the STA to determine the post-FEC padding factor value based on the pre-FEC padding factor value.

Example 31 includes the subject matter of any one of Examples 28-30, and optionally, wherein the apparatus is configured to cause the STA to determine a number of coded bits for a last Orthogonal Frequency Division Multiplexing (OFDM) symbol of the PPDU based on the post-FEC padding factor value, and to encode the data field of the PPDU based on the number of coded bits for the last OFDM symbol of the PPDU.

Example 32 includes the subject matter of Example 31, and optionally, wherein the apparatus is configured to cause the STA to determine a number of available bits for the data field based on the number of coded bits for the last OFDM symbol of the PPDU, and to encode the data field of the PPDU based on the number of available bits for the data field.

Example 33 includes the subject matter of Example 31 or 32, and optionally, wherein the apparatus is configured to cause the STA to determine the post-FEC padding factor value comprising an initial post-FEC padding factor value, and to determine the number of coded bits for the last OFDM symbol of the PPDU comprising a number of coded bits for the last OFDM symbol for a u-th user as follows:

$${N}_{C B P S , l a s t , i n i t , u} = \{ \begin{matrix}{b}_{init} \cdot {N}_{CBPS , short , u} & if {b}_{init} < {2}^{{N}_{b}} \\ {N}_{CBPS , u} & if {b}_{init} = {2}^{{N}_{b}}\end{matrix}$$

wherein N_{CBPS,last,init,u} denotes the number of coded bits for the last OFDM symbol for the u-th user, wherein bᵢₙᵢₜ denotes the initial post-FEC padding factor value, wherein N_{CBPS,u} denotes a number of coded bits per OFDM symbol for the u-th user, wherein N_{CBPS,short,u} denotes a short number of coded bits per OFDM symbol for the u-th user.

Example 34 includes the subject matter of any one of Examples 28-33, and optionally, wherein the apparatus is configured to cause the STA to determine the post-FEC padding factor value comprising an initial post-FEC padding factor value as follows:

$${b}_{i n i t} = ⌈ \frac{{a}_{i n i t}}{{2}^{{N}_{a}} / {2}^{{N}_{b}}} ⌉$$

wherein bᵢₙᵢₜ denotes the initial post-FEC padding factor value, wherein aᵢₙᵢₜ denotes the initial pre-FEC padding factor value, wherein aᵢₙᵢₜ is in a range between 1 and 2Nₐ.

Example 35 includes the subject matter of any one of Examples 28-34, and optionally, wherein N_{b}=0.

Example 36 includes the subject matter of any one of Examples 28-34, and optionally, wherein N_{b}=1.

Example 37 includes the subject matter of any one of Examples 28-34, and optionally, wherein the post-FEC padding factor value is equal to the pre-FEC padding factor value.

Example 38 includes the subject matter of any one of Examples 28-34, and optionally, wherein the post-FEC padding factor value is different from the pre-FEC padding factor value.

Example 39 includes the subject matter of any one of Examples 28-38, and optionally, wherein the FEC coding comprises a Low-Density Parity Check (LDPC) coding.

Example 40 includes the subject matter of any one of Examples 28-39, and optionally, wherein the PPDU comprises a Multi-User (MU) PPDU for a plurality of users, wherein the post-FEC padding factor value comprises a common post-FEC padding factor value to be applied for all users.

Example 41 includes the subject matter of any one of Examples 28-40, and optionally, wherein the PPDU comprises a Single-User (SU) PPDU for a single user.

Example 42 includes the subject matter of any one of Examples 28-41, and optionally, comprising a radio to transmit the PPDU.

Example 43 includes the subject matter of Example 42, and optionally, comprising one or more antennas connected to the radio, and a processor to execute instructions of an operating system.

Example 44 includes an apparatus comprising logic and circuitry configured to cause a wireless communication station (STA) to determine a pre Forward Error Correction (FEC) (pre-FEC) padding factor value for a Physical Layer (PHY) Protocol Data Unit (PPDU); encode a data field of the PPDU according to a FEC coding based on the pre-FEC padding factor value and based on a condition that no post-FEC padding is to be applied for the PPDU; and set a Low-Density Parity Check (LDPC) extra symbol subfield in a Signal (SIG) field of the PPDU to indicate whether or not an LDPC extra symbol is present based on encoding of the data field of the PPDU.

Example 45 includes the subject matter of Example 44, and optionally, wherein the apparatus is configured to cause the STA to determine a number of available bits for the data field of the PPDU based on the condition that no post-FEC padding is to be applied, and to encode the data field of the PPDU based on the number of available bits for the data field of the PPDU.

Example 46 includes the subject matter of Example 44 or 45, and optionally, wherein the apparatus is configured to cause the STA to determine a number of available bits for the data field of the PPDU, to encode the data field of the PPDU based on the number of available bits for the data field of the PPDU, and to set the LDPC extra symbol subfield based on whether the number of available bits for the data field of the PPDU is determined according to a first predefined calculation or a second predefined calculation.

Example 47 includes the subject matter of Example 46, and optionally, wherein the first predefined calculation comprises a calculation of a number of available bits for a u-th user as follows:

N_{avbits,u}=N_{SYM,init}N_{CBPS,u}

wherein N_{avbits,u} denotes the number of available bits for the u-th user, wherein N_{SYM}, init denotes an initial number of Orthogonal Frequency Division Multiplexing (OFDM) symbols, wherein N_{CBPS,u} denotes a number of coded bits per OFDM symbol for the u-th user.

Example 48 includes the subject matter of Example 46 or 47, and optionally, wherein the apparatus is configured to cause the STA to set the LDPC extra symbol subfield to a value of “0” based on use of the first predefined calculation for determination of the number of available bits for the data field of the PPDU.

Example 49 includes the subject matter of any one of Examples 46-48, and optionally, wherein the second predefined calculation comprises a calculation of a number of available bits for a u-th user as follows:

N_{avbits,u}=N_{SYM,init}N_{CBPS,u}+N_{CBPS,u}

wherein N_{avbits,u} denotes the number of available bits for the u-th user,
wherein N_{SYM,init} denotes an initial number of Orthogonal Frequency Division Multiplexing (OFDM) symbols, wherein N_{CBPS,u} denotes a number of coded bits per OFDM symbol for the u-th user.

Example 50 includes the subject matter of any one of Examples 46-49, and optionally, wherein the apparatus is configured to cause the STA to set the LDPC extra symbol subfield to a value of “1” based on use of the second predefined calculation for determination of the number of available bits for the data field of the PPDU.

Example 51 includes the subject matter of any one of Examples 44-50, and optionally, wherein the apparatus is configured to cause the STA to set the LDPC extra symbol subfield to a value of “1” or a value of “0”, the value of “1” to indicate that an LDPC extra symbol is present, the value of “0” to indicate that an LDPC extra symbol is not present.

Example 52 includes the subject matter of any one of Examples 44-51, and optionally, wherein the LDPC extra symbol subfield is a single-bit subfield.

Example 53 includes the subject matter of any one of Examples 44-52, and optionally, wherein the LDPC extra symbol subfield is a bit B9 of a common information field in the SIG field.

Example 54 includes the subject matter of any one of Examples 44-53, and optionally, wherein the apparatus is configured to cause the STA to encode the data field of the PPDU such that a PHY boundary for the PPDU is independent of the pre-FEC padding factor value.

Example 55 includes the subject matter of any one of Examples 44-54, and optionally, wherein the apparatus is configured to cause the STA to encode the data field of the PPDU such that a PHY boundary for the PPDU is equal to a number of Orthogonal Frequency Division Multiplexing (OFDM) symbols for the PPDU.

Example 56 includes the subject matter of any one of Examples 44-55, and optionally, wherein the apparatus is configured to cause the STA to determine a duration of a Packet Extension (PE) field in the PPDU independent of the pre-FEC padding factor value.

Example 57 includes the subject matter of any one of Examples 44-56, and optionally, wherein the FEC coding comprises an LDPC coding.

Example 58 includes the subject matter of any one of Examples 44-57, and optionally, wherein the PPDU comprises a Multi-User (MU) PPDU for a plurality of users, wherein encoding of the data field of the PPDU according to the FEC coding is configured such that a common number of Orthogonal Frequency Division Multiplexing (OFDM) symbols is to be applied for all users.

Example 59 includes the subject matter of any one of Examples 44-57, and optionally, wherein the PPDU comprises a Single-User (SU) PPDU for a single user.

Example 60 includes the subject matter of any one of Examples 44-59, and optionally, comprising a radio to transmit the PPDU.

Example 61 includes the subject matter of Example 60, and optionally, comprising one or more antennas connected to the radio, and a processor to execute instructions of an operating system.

Example 62 includes the subject matter of any of examples 1-27 in combination with the subject matter of any of examples 28-43.

Example 63 includes the subject matter of any of examples 1-27 in combination with the subject matter of any of examples 44-61.

Example 64 includes the subject matter of any of examples 28-43 in combination with the subject matter of any of examples 44-61.

Example 65 includes the subject matter of any of examples 1-27 in combination with the subject matter of any of examples 28-43, and further in combination with the subject matter of any of examples 44-61.

Example 66 includes a wireless communication device comprising the apparatus of any of Examples 1-65.

Example 67 includes a mobile device comprising the apparatus of any of Examples 1-65.

Example 68 includes an apparatus comprising means for executing any of the described operations of any of Examples 1-65.

Example 69 includes a product comprising one or more tangible computer-readable non-transitory storage media comprising instructions operable to, when executed by at least one processor, enable the at least one processor to cause a wireless communication device to perform any of the described operations of any of Examples 1-65.

Example 70 includes an apparatus comprising: a memory interface; and processing circuitry configured to: perform any of the described operations of any of Examples 1-65.

Example 71 includes a method comprising any of the described operations of any of Examples 1-65.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a wireless communication station (STA) to:
determine a pre Forward Error Correction (FEC) (pre-FEC) padding factor value for a Physical Layer (PHY) Protocol Data Unit (PPDU), the pre-FEC padding factor value in a range between 1 and 2^{Na}, wherein Na is an integer greater than 2;
set Nₐ bits in a Signal (SIG) field of the PPDU to indicate the pre-FEC padding factor value; and
encode a data field of the PPDU according to a FEC coding based on the pre-FEC padding factor value.

2. The apparatus of claim 1 configured to cause the STA to determine a number of pre-FEC padding bits based on the pre-FEC padding factor value, and to encode the data field of the PPDU according to the FEC coding using the number of pre-FEC padding bits.

3. The apparatus of claim 1 configured to cause the STA to determine a number of data bits for a last Orthogonal Frequency Division Multiplexing (OFDM) symbol of the PPDU based on the pre-FEC padding factor value, and to encode the data field of the PPDU based on the number of data bits for the last OFDM symbol of the PPDU.

4. The apparatus of claim 3 configured to cause the STA to determine a total number of bits in a PHY Service Data Unit (PSDU) and service field based on the number of data bits for the last OFDM symbol of the PPDU, and to encode the data field of the PPDU based on the total number of bits in the PSDU and the service field.

5. The apparatus of claim 3 configured to cause the STA to determine the pre-FEC padding factor value comprising an initial pre-FEC padding factor value, and to determine the number of data bits for the last OFDM symbol of the PPDU comprising a number of data bits for the last OFDM symbol for a u-th user as follows:
$${N}_{D B P S , l a s t , i n i t , u} = \{ \begin{matrix}{a}_{init} \cdot {N}_{DBPS , short , u} & if {a}_{init} < {2}^{{N}_{a}} \\ {N}_{DBPS , u} & if {a}_{init} = {2}^{{N}_{a}}\end{matrix}$$
wherein N_{DBPS,last,init,u} denotes the number of data bits for the last OFDM symbol for the u-th user,
wherein aᵢₙᵢₜ denotes the initial pre-FEC padding factor value,
wherein N_{DBPS,u} denotes a number of data bits per OFDM symbol for the u-th user,
wherein N_{DBPS,short,u} denotes a short number of data bits per OFDM symbol for the u-th user.

6. The apparatus of claim 1 configured to cause the STA to determine the pre-FEC padding factor value comprising an initial pre-FEC padding factor value for a u-th user as follows:
$${a}_{i n i t , u} = \{ \begin{matrix}{2}^{{N}_{a}} , & if {N}_{Excess , u} = 0 \\ min ( [ \frac{{N}_{Excess , u}}{{N}_{DBPS , short , u}} ] , {2}^{{N}_{a}} ) , & otherwise\end{matrix}$$
wherein a_{init,u} denotes the initial pre-FEC padding factor value for the u-th user,
wherein N_{Excess,u} denotes a number of data bits left in a last Orthogonal Frequency Division Multiplexing (OFDM) symbol for the u-th user,
wherein N_{DBPS,short,u} denotes a short number of data bits per OFDM symbol for the u-th user.

7. The apparatus of claim 1 configured to cause the STA to determine the pre-FEC padding factor value based on a number of data bits left in a last Orthogonal Frequency Division Multiplexing (OFDM) symbol of the PPDU.

8. The apparatus of claim 1 configured to cause the STA to configure a Medium Access Control (MAC) pre-FEC padding boundary for the PPDU based on the pre-FEC padding factor value, and to encode the data field of the PPDU according to the FEC coding based on the MAC pre-FEC padding boundary, wherein the MAC pre-FEC padding boundary comprises a number of symbol segments, in the range between 1 and 2^{Na}, for MAC pre-FEC padding in a last Orthogonal Frequency Division Multiplexing (OFDM) symbol of the PPDU.

9. The apparatus of claim 1 configured to cause the STA to set an other bit in the SIG field such that a combination of the Na bits and the other bit is to indicate a Medium Access Control (MAC) pre-FEC padding boundary for the PPDU.

10. The apparatus of claim 9, wherein the other bit comprises a bit representing a Low-Density Parity Check (LDPC) extra symbol segment subfield or an LDPC extra symbol subfield.

11. The apparatus of claim 1 configured to cause the STA to configure the FEC coding based on the pre-FEC padding factor value such that no post-FEC padding is to be applied for the PPDU.

12. The apparatus of claim 1 configured to cause the STA to:
determine a post FEC (post-FEC) padding factor value for the PPDU, the post-FEC padding factor value in a range between 1 and 2^{Nb}, wherein Nb is equal to or greater than 0; and
encode the data field of the PPDU according to the FEC coding based on the post-FEC padding factor value.

13. The apparatus of claim 12 configured to cause the STA to determine the post-FEC padding factor value based on the pre-FEC padding factor value and a ratio between 2^{Na} and 2^{Nb} (2^{Na}/2^{Nb}).

14. The apparatus of claim 12 configured to cause the STA to determine a number of coded bits for a last Orthogonal Frequency Division Multiplexing (OFDM) symbol of the PPDU based on the post-FEC padding factor value, and to encode the data field of the PPDU based on the number of coded bits for the last OFDM symbol of the PPDU.

15. The apparatus of claim 14 configured to cause the STA to determine a number of available bits for the data field based on the number of coded bits for the last OFDM symbol of the PPDU, and to encode the data field of the PPDU based on the number of available bits for the data field.

16. The apparatus of claim 12 configured to cause the STA to set the Nₐ bits to indicate both the pre-FEC padding factor value and the post-FEC padding factor value.

17. The apparatus of claim 1 comprising a radio to transmit the PPDU.

18. The apparatus of claim 17 comprising one or more antennas connected to the radio, and a processor to execute instructions of an operating system.

19. A product comprising one or more tangible computer-readable non-transitory storage media comprising instructions operable to, when executed by at least one processor, enable the at least one processor to cause a wireless communication station (STA) to:
determine a pre Forward Error Correction (FEC) (pre-FEC) padding factor value for a Physical Layer (PHY) Protocol Data Unit (PPDU), the pre-FEC padding factor value in a range between 1 and 2^{Na}, wherein Na is an integer greater than 2;
set Na bits in a Signal (SIG) field of the PPDU to indicate the pre-FEC padding factor value; and
encode a data field of the PPDU according to a FEC coding based on the pre-FEC padding factor value.

20. The product of claim 19, wherein the instructions, when executed, cause the STA to:
determine a post FEC (post-FEC) padding factor value for the PPDU, the post-FEC padding factor value in a range between 1 and 2^{Nb}, wherein Nb is equal to or greater than 0; and
encode the data field of the PPDU according to the FEC coding based on the post-FEC padding factor value.
